(19) United States
(12) Patent Application Publication
(10) Pub. No.: US 2026/0221519 A1
(43) Pub. Date: Jul. 30, 2026

(54) SECONDARY BATTERY AND BATTERY PACK

(71) Applicant: MURATA MANUFACTURING CO., LTD., Kyoto (JP)

(72) Inventors: Kei WAKABAYASHI, Kyoto (JP); Toshikazu NAKAMURA, Kyoto (JP); Kentaro OKAMOTO, Kyoto (JP); Kazutaka OZAWA, Kyoto (JP); Miki MIYAZAKI, Kyoto (JP)

(21) Appl. No.: 19/576,966

(22) Filed: Mar. 24, 2026

Related U.S. Application Data
(63) Continuation of application No. PCT/JP2024/038684, filed on Oct. 30, 2024.

(30) Foreign Application Priority Data
Nov. 14, 2023 (JP) 2023-193649

(51) Int. Cl. H01M 10/0587; H01M 4/02; H01M 4/36; H01M 50/107

(52) U.S. Cl. CPC H01M 10/0587; H01M 4/366; H01M 50/107; H01M 2004/028

(57) ABSTRACT

A secondary battery is provided and includes an electrode wound body and an outer package can. The electrode wound body includes a stacked body and has a through hole. The stacked body includes a positive electrode, a negative electrode, and a separator and is wound along a longitudinal direction of the stacked body. The through hole extends through the electrode wound body in a width direction orthogonal to the longitudinal direction. The outer package can includes the electrode wound body. The positive electrode includes a positive electrode current collector and a positive electrode active material layer. The positive electrode current collector extends in both the longitudinal direction and the width direction. The positive electrode active material layer is provided on the positive electrode current collector and includes a thin part and a thick part. The thick part has a thickness greater than a thickness of the thin part. A positive electrode active material particle is present on a surface, of the thin part, on an opposite side to the positive electrode current collector. All or a part of the positive electrode active material particle includes a deactivated part. The deactivated part has a thickness smaller than 6.1 μm.

### CROSS REFERENCE TO RELATED APPLICATIONS

The present application is a continuation of International Patent Application No. PCT/JP2024/038684, filed on Oct. 30, 2024, which claims priority to Japanese Patent Application No. 2023-193649, filed on Nov. 14, 2023, the entire contents of which are incorporate herein by reference.

### BACKGROUND

The present disclosure relates to a secondary battery, and to a battery pack including the secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device contained inside an outer package member. A configuration of the secondary battery has been considered in various ways.

A secondary battery is proposed in which what is called a tabless structure is employed to thereby reduce an internal resistance and to allow for charging and discharging with a relatively large current.

### SUMMARY

The present disclosure relates to a secondary battery, and to a battery pack including the secondary battery.

Consideration has been given in various ways to improve performance of a secondary battery. However, there is still room for improvement in reliability of the secondary battery.

It is desirable to provide a secondary battery that is superior in reliability.

A secondary battery according to an embodiment of the present disclosure includes an electrode wound body and an outer package can. The electrode wound body includes a stacked body and has a through hole. The stacked body includes a positive electrode, a negative electrode, and a separator and is wound along a longitudinal direction of the stacked body. The through hole extends through the electrode wound body in a width direction orthogonal to the longitudinal direction. The outer package can contains the electrode wound body. The positive electrode includes a positive electrode current collector and a positive electrode active material layer. The positive electrode current collector extends in both the longitudinal direction and the width direction. The positive electrode active material layer is provided on the positive electrode current collector and includes a thin part and a thick part. The thick part has a thickness greater than a thickness of the thin part.

A positive electrode active material particle is present on a surface, of the thin part, on an opposite side to the positive electrode current collector. All or a part of the positive electrode active material particle includes a deactivated part. The deactivated part has a thickness smaller than 6.1 μm.

A battery pack according to an embodiment of the present disclosure includes the secondary battery described above, a controller configured to control the secondary battery, and an outer package body containing the secondary battery.

### BRIEF DESCRIPTION OF THE FIGURES

FIG. 1 is a sectional diagram illustrating a configuration example of a vertical sectional structure of a secondary battery according to an embodiment of the present disclosure, along a height direction.

FIG. 2 is a schematic diagram illustrating a configuration example of a stacked body including a positive electrode, a negative electrode, and a separator illustrated in FIG. 1.

FIG. 3 is a sectional diagram illustrating a configuration example of a horizontal sectional structure of an electrode wound body illustrated in FIG. 1.

FIG. 4A is a developed view of the positive electrode illustrated in FIG. 1.

FIG. 4B is a first sectional view of the positive electrode illustrated in FIG. 1.

FIG. 4C is a second sectional view of the positive electrode illustrated in FIG. 1.

FIG. 4D is a schematic enlarged sectional view of a part of the positive electrode illustrated in FIG. 1.

FIG. 5A is a developed view of the negative electrode illustrated in FIG. 1.

FIG. 5B is a sectional view of the negative electrode illustrated in FIG. 1.

FIG. 6A is a plan view of a positive electrode current collector plate illustrated in FIG. 1.

FIG. 6B is a plan view of a negative electrode current collector plate illustrated in FIG. 1.

FIG. 7 is a perspective diagram for describing a process of manufacturing the secondary battery illustrated in FIG. 1.

FIG. 8 is a block diagram illustrating a circuit configuration of a battery pack to which the secondary battery according to an embodiment of the present disclosure is applied.

FIG. 9A is a sectional diagram illustrating a first example of a positive electrode according to an embodiment of the present disclosure.

FIG. 9B is a sectional diagram illustrating a second example of the positive electrode according to an embodiment of the present disclosure.

FIG. 9C is a sectional diagram illustrating a third example of the positive electrode according to an embodiment of the present disclosure.

FIG. 10A is a developed view of a positive electrode according to an embodiment of the present disclosure.

FIG. 10B is a sectional view of the positive electrode illustrated in FIG. 10A.

FIG. 11A is a developed view of a positive electrode according to an embodiment of the present disclosure.

FIG. 11B is a developed view of a negative electrode to be used together with the positive electrode illustrated in FIG. 11A.

FIG. 12A is a first sectional view of the positive electrode illustrated in FIG. 11A.

FIG. 12B is a second sectional view of the positive electrode illustrated in FIG. 11A.

FIG. 13A is a scanning electron microscope (SEM) section image of a part of a positive electrode of Example 1.

FIG. 13B is an explanatory diagram illustrating a result of measuring a composition of a positive electrode active material layer of Example 1.

FIG. 14 is a sectional diagram illustrating a configuration example of a vertical sectional structure of a secondary battery according to an embodiment of the present disclosure, along a height direction of the secondary battery.

### DETAILED DESCRIPTION

The present disclosure are described below in further detail including with reference to the drawings according to an embodiment.

A description is given first of a secondary battery according to an embodiment of the present disclosure.

In the present embodiment, a cylindrical lithium-ion secondary battery having an outer appearance of a cylindrical shape will be described as an example. However, the secondary battery of the present disclosure is not limited to the cylindrical lithium-ion secondary battery, and may be a lithium-ion secondary battery having an outer appearance of a shape other than the cylindrical shape, or may be a secondary battery in which an electrode reactant other than lithium is used.

Although a charge and discharge principle of the secondary battery is not particularly limited, the following description deals with a case where a battery capacity is obtained through insertion and extraction of the electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind as described above, the electrode reactant is specifically a light metal such as an alkali metal or an alkaline earth metal. Examples of the alkali metal include lithium, sodium, and potassium. Examples of the alkaline earth metal include beryllium, magnesium, and calcium.

In the following, described as an example is a case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

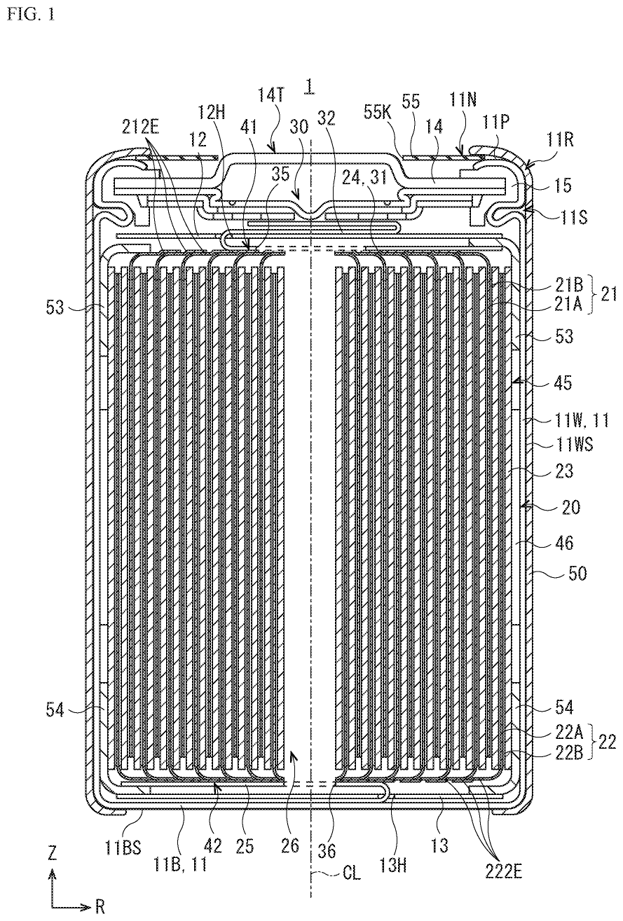

FIG. 1 illustrates a vertical sectional configuration of a lithium-ion secondary battery 1 (hereinafter simply referred to as a secondary battery 1) according to the present embodiment, along a height direction. The secondary battery 1 illustrated in FIG. 1 includes an outer package can 11 and an electrode wound body 20. The outer package can 11 has a substantially cylindrical shape. The electrode wound body 20 is contained inside the outer package can 11 and serves as a battery device. The secondary battery 1 further includes an outer package tube 50. The outer package tube 50 covers an outer peripheral surface of the outer package can 11. Note that herein, the height direction of the secondary battery 1 corresponds to a Z-axis direction.

Specifically, the secondary battery 1 includes, inside the outer package can 11, a pair of insulating plates 12 and 13, the electrode wound body 20, a positive electrode current collector plate 24, and a negative electrode current collector plate 25, for example. The electrode wound body 20 is a structure in which a positive electrode 21 and a negative electrode 22 are stacked with a separator 23 interposed therebetween and are wound, for example. The electrode wound body 20 is impregnated with an electrolytic solution. The electrolytic solution is a liquid electrolyte. Note that the secondary battery 1 may further include a thermosensitive resistive (PTC) device, a reinforcing member, or both inside the outer package can 11.

The outer package can 11 is a container that contains components including, without limitation, the positive electrode current collector plate 24, the negative electrode current collector plate 25, and the electrode wound body 20. The outer package can 11 includes a bottom part 11B and a sidewall part 11W. The bottom part 11B also serves as a negative electrode terminal coupled to the negative electrode 22 via the negative electrode current collector plate 25. The outer package can 11 has, for example, a hollow cylindrical structure having a lower end part and an upper end part in the Z-axis direction. The lower end part is closed, and the upper end part is open. The upper end part of the outer package can 11 is thus an open end part 11N. The lower end part of the outer package can 11 is closed by the bottom part 11B having a substantially circular plate shape. The sidewall part 11W is provided between the open end part 11N and the bottom part 11B and surrounds the electrode wound body 20. The sidewall part 11W so stands in the height direction and along an outer edge of the bottom part 11B as to surround the electrode wound body 20. The sidewall part 11W includes the open end part 11N on an opposite side to the bottom part 11B. The open end part 11N is open to allow the electrode wound body 20 to be passed through the open end part 11N. The outer package can 11 includes, for example, a metal material such as iron as a constituent material. Note that a surface of the outer package can 11 may be plated with, for example, a metal material such as nickel. The insulating plate 12 and the insulating plate 13 are so opposed to each other as to allow the electrode wound body 20 to be interposed therebetween in the Z-axis direction, for example. Note that herein, the open end part 11N and the vicinity thereof may be referred to as an upper part of the secondary battery 1 in the Z-axis direction, and a region where the outer package can 11 is closed and the vicinity thereof may be referred to as a lower part of the secondary battery 1 in the Z-axis direction.

The outer package tube 50 surrounds a side surface 11WS that is an outer surface of the sidewall part 11W of the outer package can 11. The outer package tube 50 may, however, cover a bent part 11P provided at the upper end part of the outer package can 11, as illustrated in FIG. 1. The bent part 11P will be described later. Further, the outer package tube 50 may cover a part of a bottom surface 11BS that is an outer surface of the bottom part 11B of the outer package can 11. The outer package tube 50 includes, for example, a thermally contractible insulating film that includes a material such as a polyester-based resin, a polyamide-based resin, or a thermoplastic elastomer resin.

A washer 55 is provided in a gap between the outer package tube 50 and the bent part 11P of the outer package can 11. The washer 55 is an insulating ring member that has an opening 55K in a middle region in a plane orthogonal to the height direction. Disposed in the opening 55K is a projecting part 14T provided in a middle region of a battery cover 14. The washer 55 may include, for example, black modified polyphenylene ether as a constituent material.

Each of the insulating plates 12 and 13 is, for example, a dish-shaped plate having a surface perpendicular to a central axis CL of the electrode wound body 20, that is, a surface perpendicular to a Z-axis in FIG. 1. The insulating plates 12 and 13 are so disposed as to allow the electrode wound body 20 to be interposed therebetween.

For example, a structure in which the battery cover 14 and a safety valve mechanism 30 are crimped with a gasket 15 interposed between the open end part 11N and both the battery cover 14 and the safety valve mechanism 30, that is, a crimped structure 11R, is provided at the open end part 11N of the outer package can 11. The outer package can 11 is sealed by the battery cover 14, with the electrode wound body 20 and other components being contained inside the outer package can 11. The crimped structure 11R includes the bent part 11P serving as what is called a crimp part. In addition, a narrow part 11S is provided between the bent part 11P and the insulating plate 12. The narrow part 11S is a part of the outer package can 11 that protrudes inward.

The battery cover 14 is a closing member that closes the open end part 11N in a state where the electrode wound body 20 and other components are contained inside the outer package can 11. The battery cover 14 is, for example, an electrical conductor that includes a material similar to the material included in the outer package can 11. The battery cover 14 closes the open end part 11N of the outer package can 11 and is coupled to the positive electrode current collector plate 24. Therefore, the battery cover 14 also serves as a positive electrode terminal coupled to the positive electrode 21 via the positive electrode current collector plate 24. The middle region of the battery cover 14 protrudes upward, i.e., in a +Z direction, for example. As a result, a peripheral region, i.e., a region other than the middle region, of the battery cover 14 is in a state of being in contact with the safety valve mechanism 30, for example.

The gasket 15 is a sealing member interposed between the bent part 11P of the outer package can 11 and the battery cover 14. The gasket 15 seals a gap between the bent part 11P and the battery cover 14. Note that a surface of the gasket 15 may be coated with, for example, a material such as asphalt. The gasket 15 includes any one or more of insulating materials, for example. The insulating material is not particularly limited in kind, and examples thereof include a polymer material such as polybutylene terephthalate (PBT) or polypropylene (PP). In some embodiments, the insulating material is polybutylene terephthalate. One reason for this is that this allows the gap between the bent part 11P and the battery cover 14 to be sufficiently sealed, with the outer package can 11 and the battery cover 14 being electrically separated from each other.

The safety valve mechanism 30 is adapted to cancel the sealed state of the outer package can 11 to thereby release a pressure inside the outer package can 11, i.e., an internal pressure of the outer package can 11 on an as-needed basis, mainly upon an increase in the internal pressure. Examples of a cause of the increase in the internal pressure of the outer package can 11 include a gas generated due to a decomposition reaction of the electrolytic solution upon charging and discharging. The internal pressure of the outer package can 11 can also increase due to heating from outside.

The electrode wound body 20 is disposed between the positive electrode current collector plate 24 and the negative electrode current collector plate 25. The electrode wound body 20 has an upper end face 41 and a lower end face 42. The upper end face 41 faces the positive electrode current collector plate 24 in the height direction. The lower end face 42 faces the negative electrode current collector plate 25 in the height direction. The electrode wound body 20 is a power generation device that causes charging and discharging reactions to proceed, and is contained inside the outer package can 11. The electrode wound body 20 includes the positive electrode 21, the negative electrode 22, the separator 23, and the electrolytic solution as a liquid electrolyte.

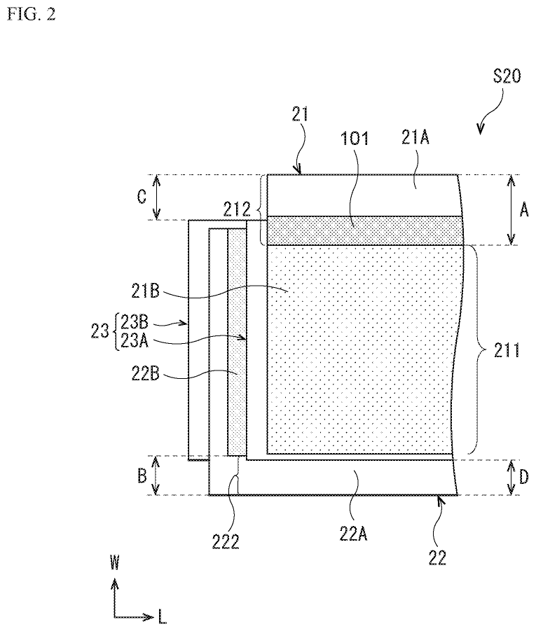

FIG. 2 is a developed view of the electrode wound body 20, and schematically illustrates a part of a stacked body S20 including the positive electrode 21, the negative electrode 22, and the separator 23. In the stacked body S20 that corresponds to the electrode wound body 20 in an unwound state, the positive electrode 21 and the negative electrode 22 are stacked on each other with the separator 23 interposed therebetween. The separator 23 includes, for example, two bases, that is, a first separator member 23A and a second separator member 23B. Accordingly, the electrode wound body 20 includes the stacked body S20 that is four-layered. In the four-layered stacked body S20, the positive electrode 21, the first separator member 23A, the negative electrode 22, and the second separator member 23B are stacked in order. Each of the positive electrode 21, the first separator member 23A, the negative electrode 22, and the second separator member 23B is a substantially band-shaped member in which a W direction corresponds to a transverse direction and an L direction corresponds to a longitudinal direction.

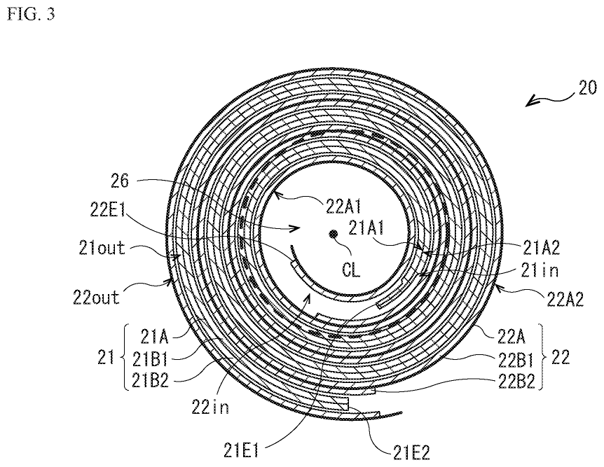

As illustrated in FIG. 3, the electrode wound body 20 is the stacked body S20 so wound around a through hole 26 that extends along the central axis CL extending in the Z-axis direction as to form a spiral shape in a horizontal section orthogonal to the Z-axis direction. Here, the stacked body S20 is wound in an orientation in which the W direction substantially coincides with the Z-axis direction. Note that FIG. 3 illustrates a configuration example of the electrode wound body 20 along the horizontal section orthogonal to the Z-axis direction. Note that, for higher visibility, FIG. 3 omits illustration of the separator 23. The electrode wound body 20 has an outer appearance of a substantially circular columnar shape as a whole. The positive electrode 21 and the negative electrode 22 are wound, remaining in a state of being opposed to each other with the separator 23 interposed therebetween. The electrode wound body 20 has the through hole 26 as an internal space at a center thereof. The through hole 26 is a hole into which a winding core for assembling the electrode wound body 20 and an electrode rod for welding are each to be put. The through hole 26 extends in the Z-axis direction along the central axis CL, and extends through the electrode wound body 20. The stacked body S20 is thus wound around the through hole 26.

The positive electrode 21, the negative electrode 22, and the separator 23 are so wound that the separator 23 is positioned in each of an outermost wind of the electrode wound body 20 and an innermost wind of the electrode wound body 20. Further, in the outermost wind of the electrode wound body 20, the negative electrode 22 is positioned on an outer side relative to the positive electrode 21. In other words, as illustrated in FIG. 3, an outermost positive electrode wind part 21out that is positioned in an outermost wind of the positive electrode 21 included in the electrode wound body 20 is positioned on an inner side relative to an outermost negative electrode wind part 22out that is positioned in an outermost wind of the negative electrode 22 included in the electrode wound body 20. Here, the outermost positive electrode wind part 21out is a part corresponding to the outermost one wind of the positive electrode 21 in the electrode wound body 20. The outermost negative electrode wind part 22out is a part corresponding to the outermost one wind of the negative electrode 22 in the electrode wound body 20. In contrast, in the innermost wind of the electrode wound body 20, the negative electrode 22 is positioned on the inner side relative to the positive electrode 21. In other words, as illustrated in FIG. 3, an innermost negative electrode wind part 22 in that is positioned in an innermost wind of the negative electrode 22 included in the electrode wound body 20 is positioned on the inner side relative to an innermost positive electrode wind part 21 in that is positioned in an innermost wind of the positive electrode 21 included in the electrode wound body 20. Here, the innermost positive electrode wind part 21in is a part corresponding to the innermost one wind of the positive electrode 21 in the electrode wound body 20. The innermost negative electrode wind part 22 in is a part corresponding to the innermost one wind of the negative electrode 22 in the electrode wound body 20. The number of winds of each of the positive electrode 21, the negative electrode 22, and the separator 23 is not particularly limited, and may be chosen as desired.

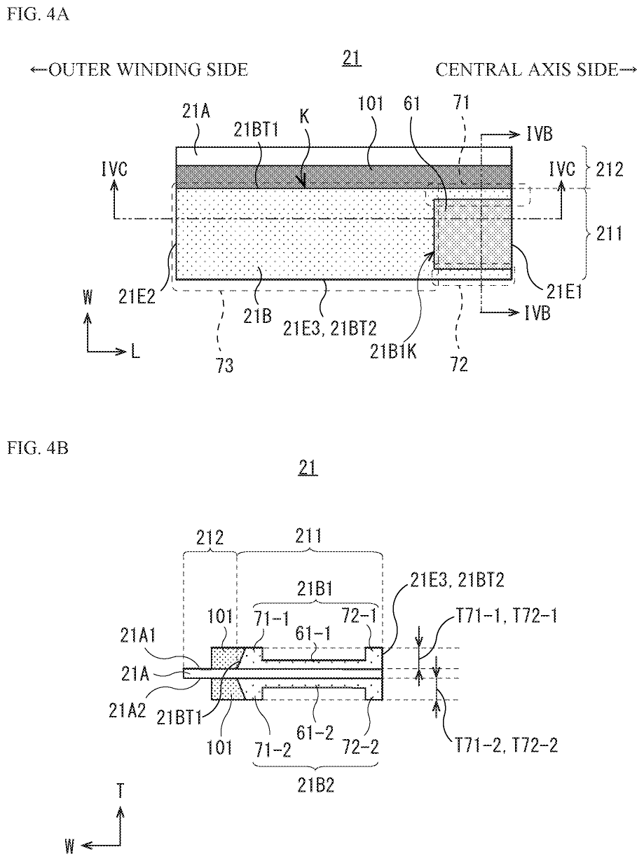

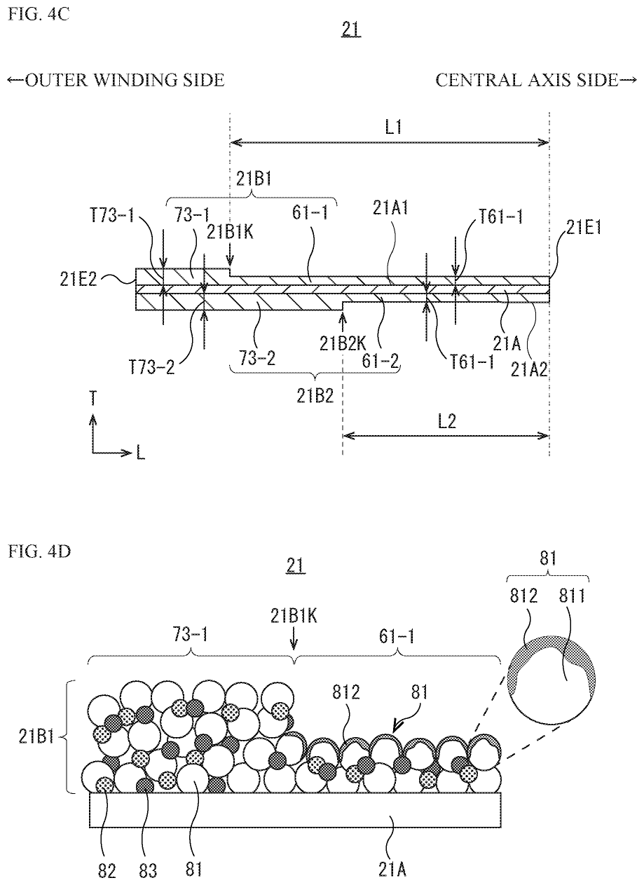

FIG. 4A is a developed view of the positive electrode 21, and schematically illustrates a state before being wound. FIGS. 4B and 4C each illustrate a sectional configuration of the positive electrode 21. Note that FIG. 4B illustrates a section of the positive electrode 21 as viewed in an arrowed direction along line IVB-IVB illustrated in FIG. 4A. FIG. 4C illustrates a section of the positive electrode 21 as viewed in an arrowed direction along line IVC-IVC illustrated in FIG. 4A. The positive electrode 21 includes a positive electrode current collector 21A, a positive electrode active material layer 21B, and an insulating layer 101. In each of FIGS. 4B and 4C, a stacking direction of the positive electrode current collector 21A and the positive electrode active material layer 21B is referred to as a T direction. Note that herein, the T direction may be referred to as a thickness direction of the positive electrode 21. For example, the positive electrode active material layer 21B may be provided only on one of two opposite surfaces of the positive electrode current collector 21A, or may be provided on each of the two opposite surfaces of the positive electrode current collector 21A. FIG. 4B illustrates a case where the positive electrode active material layer 21B is provided on each of the two opposite surfaces of the positive electrode current collector 21A. More specifically, the positive electrode current collector 21A includes an inward positive electrode current collector surface 21A1 facing toward the central axis CL, and an outward positive electrode current collector surface 21A2 positioned on a side opposite to the inward positive electrode current collector surface 21A1. The positive electrode 21 includes, as the positive electrode active material layers 21B, an inner winding side positive electrode active material layer 21B1 covering all or a part of the inward positive electrode current collector surface 21A1, and an outer winding side positive electrode active material layer 21B2 covering all or a part of the outward positive electrode current collector surface 21A2. Note that herein, the inner winding side positive electrode active material layer 21B1 and the outer winding side positive electrode active material layer 21B2 may each be generically referred to as the positive electrode active material layer 21B, without being distinguished from each other. The positive electrode active material layer 21B extends in both the L direction and the W direction orthogonal to the L direction. The L direction is a winding direction of the stacked body S20. The W direction substantially coincides with the central axis CL.

The positive electrode current collector 21A includes a positive electrode covered region 211 and a positive electrode exposed region 212. The positive electrode covered region 211 is covered with the positive electrode active material layer 21B. The positive electrode exposed region 212 is not covered with the positive electrode active material layer 21B and may protrude in the W direction. The insulating layer 101 extends in the L direction, along a first edge 21BT1 of the positive electrode active material layer 21B. The first edge 21BT1 is positioned at a border K between the positive electrode covered region 211 and the positive electrode exposed region 212. Note that in the positive electrode 21 in the present embodiment, the first edge 21BT1 of the positive electrode active material layer 21B has an inclined surface as illustrated in FIG. 4B, and the insulating layer 101 is in contact with the first edge 21BT1. In other words, the insulating layer 101 is so provided as to cover the first edge 21BT1 of the positive electrode active material layer 21B and the vicinity thereof. The positive electrode active material layer 21B includes a thin part 61 and thick parts 71 to 73. In the positive electrode 21 of the present embodiment, each of the thin part 61 and the thick parts 71 to 73 is provided on each of the inward positive electrode current collector surface 21A1 and the outward positive electrode current collector surface 21A2. In other words, each of the inner winding side positive electrode active material layer 21B1 and the outer winding side positive electrode active material layer 21B2 includes each of the thin part 61 and the thick parts 71 to 73. Note, however, that it suffices that, in the positive electrode 21, at least either of the inner winding side positive electrode active material layer 21B1 or the outer winding side positive electrode active material layer 21B2 includes the thin part 61 and the thick parts 71 to 73. Note that, for convenience, in FIGS. 4B and 4C, the thin part 61 and the thick parts 71, 72, and 73 included in the inner winding side positive electrode active material layer 21B1 are respectively denoted as a thin part 61-1 and thick parts 71-1, 72-1, and 73-1; and the thin part 61 and the thick parts 71, 72, and 73 included in the outer winding side positive electrode active material layer 21B2 are respectively denoted as a thin part 61-2 and thick parts 71-2, 72-2, and 73-2. Further, as illustrated in FIG. 4C, a position of a border 21B1K between the thin part 61-1 and the thick part 73-1 in the L direction is different from a position of a border 21B2K between the thin part 61-2 and the thick part 73-2 in the L direction. In other words, a length L1 from a winding center side edge 21E1 to the position of the border 21BIK and a length L2 from the winding center side edge 21E1 to the position of the border 21B2K are different from each other.

Each of the thick parts 71 to 73 has a thickness greater than a thickness of the thin part 61. For example, the thickness of the thin part 61 may be about half the thickness of each of the thick parts 71 to 73. The respective thicknesses of the thick parts 71 to 73 may be equal to each other, or may be different from each other. Specifically, as illustrated in each of FIGS. 4B and 4C, in the inner winding side positive electrode active material layer 21B1, each of a thickness T71-1 of the thick part 71-1, a thickness T72-1 of the thick part 72-1, and a thickness T73-1 of the thick part 73-1 is greater than a thickness T61-1 of the thin part 61-1. Note that in the example illustrated in FIGS. 4B and 4C, the thickness T71-1 of the thick part 71-1, the thickness T72-1 of the thick part 72-1, and the thickness T73-1 of the thick part 73-1 are equal to each other. Similarly, in the outer winding side positive electrode active material layer 21B2, each of a thickness T71-2 of the thick part 71-2, a thickness T72-2 of the thick part 72-2, and a thickness T73-2 of the thick part 73-2 is greater than a thickness T61-2 of the thin part 61-2. Note that in the example illustrated in FIGS. 4B and 4C, the thickness T71-2 of the thick part 71-2, the thickness T72-2 of the thick part 72-2, and the thickness T73-2 of the thick part 73-2 are equal to each other. Note that the thickness T61-1 and the thickness T61-2 may be equal to each other, or may be different from each other. Further, the thickness T62-1 and the thickness T62-2 may be equal to each other, or may be different from each other. The thickness T71-1 and the thickness T71-2 may be equal to each other, or may be different from each other. The thickness T72-1 and the thickness T72-2 may be equal to each other, or may be different from each other. The thickness T73-1 and the thickness T73-2 may be equal to each other, or may be different from each other.

The thin part 61 includes the winding center side edge 21E1 of the positive electrode 21 in the L direction. The thin part 61 may have a length in the L direction that corresponds to, for example, about one wind to about five winds of the electrode wound body 20 from the winding center side edge 21E1. The thick part 71 is adjacent to the thin part 61 in the W direction. More specifically, the thick part 71 is positioned between the thin part 61 and the insulating layer 101 in the W direction. The thick part 71 may include the first edge 21BT1 and may be in contact with the insulating layer 101. The thick part 72 includes a second edge 21BT2 positioned on an opposite side to the first edge 21BT1 in the W direction. The thick part 73 is adjacent to the thin part 61 in the L direction. The thick part 73 is positioned on an opposite side of the thin part 61 to the winding center side edge 21E1 in the L direction. Note that the thick parts 71 to 73 may be separated from each other, or may be partly or entirely integrated with each other.

As illustrated in FIG. 4A, the positive electrode covered region 211 and the positive electrode exposed region 212 each extend from the winding center side edge 21E1 of the positive electrode 21 to a winding outer periphery side edge 21E2 of the positive electrode 21 along the L direction. In other words, in the positive electrode 21, the positive electrode current collector 21A is covered with the positive electrode active material layer 21B from the winding center side edge 21E1 of the positive electrode 21 to the winding outer periphery side edge 21E2 of the positive electrode 21 in the winding direction of the electrode wound body 20. The positive electrode covered region 211 and the positive electrode exposed region 212 are adjacent to each other in the W direction, i.e., the transverse direction of the positive electrode 21. Note that FIGS. 4A and 4B each schematically illustrate the positive electrode current collector 21A in a straightened state along the W direction. In actuality, however, as illustrated in FIG. 1, a positive electrode edge part 212E of the positive electrode exposed region 212 is bent toward the central axis CL and coupled to the positive electrode current collector plate 24. In other words, an end part of the positive electrode exposed region 212 in the W direction forms the upper end face 41 and is coupled to the positive electrode current collector plate 24, as illustrated in FIG. 1. The upper end face 41 includes the positive electrode edge part 212E, of the positive electrode exposed region 212, that is bent toward the through hole 26 in a wound state.

The insulating layer 101 may be provided in a region including the border K between the positive electrode covered region 211 and the positive electrode exposed region 212 and the vicinity of the border K. As with the positive electrode covered region 211 and the positive electrode exposed region 212, the insulating layer 101 also may extend from the winding center side edge 21E1 to the winding outer periphery side edge 21E2 in the electrode wound body 20. Further, the insulating layer 101 may be adhered to the first separator member 23A, the second separator member 23B, or both. One reason for this is that this makes it possible to prevent the positive electrode 21 and the separator 23 from becoming misaligned with each other. Further, the insulating layer 101 may include a resin including polyvinylidene difluoride (PVDF). One reason for this is that when the insulating layer 101 includes PVDF, the insulating layer 101 is swollen by, for example, a solvent included in the electrolytic solution, which may allow the insulating layer 101 to be favorably adhered to the separator 23.

The positive electrode current collector 21A includes an electrically conductive material such as aluminum, for example. The positive electrode current collector 21A is a metal foil including aluminum or an aluminum alloy, for example.

The positive electrode active material layer 21B includes, as a positive electrode active material, any one or more of positive electrode materials which lithium is insertable into and extractable from. Note that the positive electrode active material layer 21B may further include any one or more of other materials. Examples of the other materials include a positive electrode binder and a positive electrode conductor. The positive electrode material may be a lithium-containing compound. More specifically, the positive electrode material may be a lithium-containing composite oxide or a lithium-containing phosphoric acid compound, for example. The lithium-containing composite oxide is an oxide including lithium and one or more of other elements, that is, one or more of elements other than lithium, as constituent elements. The lithium-containing composite oxide has any of crystal structures including, without limitation, a layered rock-salt crystal structure and a spinel crystal structure, for example. The lithium-containing phosphoric acid compound is a phosphoric acid compound including lithium and one or more of other elements as constituent elements, and has a crystal structure such as an olivine crystal structure, for example. The positive electrode active material layer 21B may include, as the positive electrode active material, at least one of lithium cobalt oxide, lithium nickel cobalt manganese oxide, or lithium nickel cobalt aluminum oxide, in particular. The positive electrode binder includes, for example, any one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride and polyimide. The positive electrode conductor includes, for example, any one or more of materials including, without limitation, a carbon material. Examples of the carbon material include graphite, carbon black, acetylene black, and Ketjen black. Note that the positive electrode conductor may be any of electrically conductive materials, and may be, for example, a metal material or an electrically conductive polymer.

FIG. 4D is a sectional diagram further enlarging a part of the positive electrode 21 illustrated in FIG. 4C. Specifically, FIG. 4D illustrates a region including the border 21B1K between the thin part 61-1 and the thick part 73-1 and the vicinity of the border 21BIK. FIG. 4D illustrates only a part of the positive electrode current collector 21A and a part of the inner winding side positive electrode active material layer 21B1 of the positive electrode 21, and omits illustration of the outer winding side positive electrode active material layer 21B2. The inner winding side positive electrode active material layer 21B1 includes a plurality of positive electrode active material particles 81, as illustrated in FIG. 4D. The positive electrode active material particles 81 each include the positive electrode material described above. The inner winding side positive electrode active material layer 21B1 further includes a plurality of positive electrode binders 82 and a plurality of positive electrode conductors 83. Some of the positive electrode active material particles 81 positioned on a surface, of the thin part 61-1, on an opposite side to the positive electrode current collector 21A includes an effective part 811 and a deactivated part 812. The deactivated part 812 covers all or a part of the effective part 811. The effective part 811 of the positive electrode active material particle 81 is a part in which action of insertion and extraction of lithium is to be sufficiently achieved. In contrast, the deactivated part 812 of the positive electrode active material particle 81 is a part in which the action of insertion and extraction of lithium is not achievable or is a part in which the action of insertion and extraction of lithium is decreased as compared with the effective part 811. The deactivated part 812 of the positive electrode active material particle 81 has an oxygen mass concentration that is lower than an oxygen mass concentration of the effective part 811, of the positive electrode active material particle 81, excluding the deactivated part 812. The deactivated parts 812 are present discretely on the surface of the thin part 61-1. Further, the deactivated parts 812 have an average thickness of, for example, greater than or equal to 0.2 μm and smaller than or equal to 2.8 μm. Note that as with the thin part 61-1 described above, the thin part 61-2 of the outer winding side positive electrode active material layer 21B2 also includes the positive electrode active material particles 81 each including the effective part 811 and the deactivated part 812 covering all or a part of the effective part 811. The deactivated part 812 may have a thickness smaller than 6.1 μm.

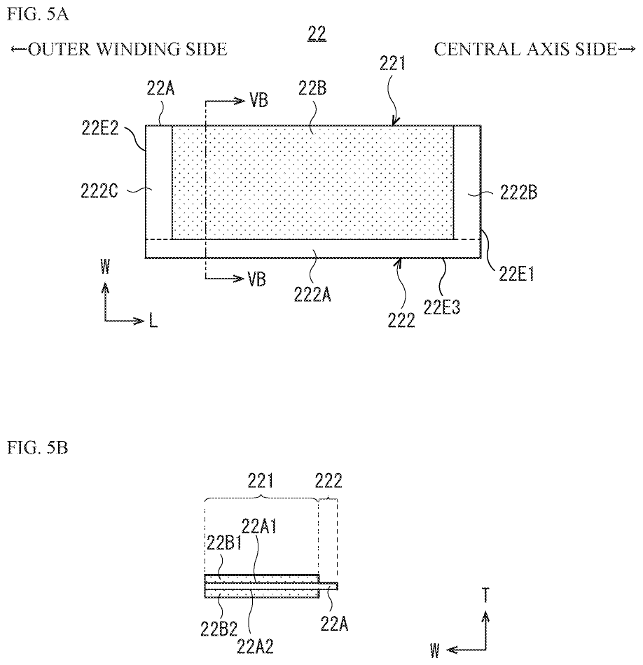

FIG. 5A is a developed view of the negative electrode 22, and schematically illustrates a state before being wound. FIG. 5B illustrates a sectional configuration of the negative electrode 22. Note that FIG. 5B illustrates a section of the negative electrode 22 as viewed in an arrowed direction along line VB-VB illustrated in FIG. 5A. The negative electrode 22 includes, for example, a negative electrode current collector 22A and a negative electrode active material layer 22B. The negative electrode active material layer 22B covers a part of the negative electrode current collector 22A. For example, the negative electrode active material layer 22B may be provided only on one of two opposite surfaces of the negative electrode current collector 22A, or may be provided on each of the two opposite surfaces of the negative electrode current collector 22A. FIG. 5B illustrates a case where the negative electrode active material layer 22B is provided on each of the two opposite surfaces of the negative electrode current collector 22A. More specifically, the negative electrode current collector 22A includes an inward negative electrode current collector surface 22A1 facing toward the winding center side of the electrode wound body 20, that is, facing toward the central axis CL, and an outward negative electrode current collector surface 22A2 facing toward the side opposite to the winding center side of the electrode wound body 20, that is, positioned on a side opposite to the inward negative electrode current collector surface 22A1. The negative electrode 22 includes, as the negative electrode active material layers 22B, an inner winding side negative electrode active material layer 22B1 covering all or a part of the inward negative electrode current collector surface 22A1, and an outer winding side negative electrode active material layer 22B2 covering all or a part of the outward negative electrode current collector surface 22A2. Note that herein, the inner winding side negative electrode active material layer 22B1 and the outer winding side negative electrode active material layer 22B2 may each be generically referred to as the negative electrode active material layer 22B, without being distinguished from each other.

The negative electrode 22 includes a negative electrode covered region 221 and a negative electrode exposed region 222. The negative electrode covered region 221 is a region in which the negative electrode current collector 22A is covered with the negative electrode active material layer 22B. The negative electrode exposed region 222 is a region in which the negative electrode current collector 22A is exposed without being covered with the negative electrode active material layer 22B. As illustrated in FIG. 5A, the negative electrode covered region 221 and the negative electrode exposed region 222 each extend along the L direction, i.e., the longitudinal direction of the negative electrode 22. The negative electrode exposed region 222 extends from a central axis side edge 22E1 of the negative electrode 22 to an outer winding side edge 22E2 of the negative electrode 22 in the winding direction of the electrode wound body 20. In contrast, the negative electrode covered region 221 is provided at neither the central axis side edge 22E1 of the negative electrode 22 nor the outer winding side edge 22E2 of the negative electrode 22. As illustrated in FIG. 5A, portions of the negative electrode exposed region 222 are so provided as to allow the negative electrode covered region 221 to be interposed therebetween in the L direction, i.e., the longitudinal direction of the negative electrode 22. Specifically, the negative electrode exposed region 222 includes a first part 222A, a second part 222B, and a third part 222C. The negative electrode 22 further has a lower edge 22E3 positioned on the side of the lower part of the electrode wound body 20 and extending in the L direction. The first part 222A is provided to be adjacent to the negative electrode covered region 221 in the W direction, and extends from the central axis side edge 22E1 of the negative electrode 22 to the outer winding side edge 22E2 of the negative electrode 22 in the L direction. The second part 222B and the third part 222C are so provided as to allow the negative electrode covered region 221 to be interposed therebetween in the L direction. The first part 222A is positioned in a region including the lower edge 22E3 of the negative electrode 22 and the vicinity of the lower edge 22E3. The second part 222B is positioned in a region including the central axis side edge 22E1 of the negative electrode 22 and the vicinity thereof, for example. The third part 222C is positioned in a region including the outer winding side edge 22E2 of the negative electrode 22 and the vicinity thereof. Note that FIGS. 5A and 5B each schematically illustrate the negative electrode current collector 22A in a state of being straightened along the W direction. In actuality, however, as illustrated in FIG. 1, a negative electrode edge part 222E of the negative electrode exposed region 222 is bent toward the central axis CL and coupled to the negative electrode current collector plate 25. In other words, an end part of the negative electrode exposed region 222 in the W direction forms the lower end face 42 and is coupled to the negative electrode current collector plate 25, as illustrated in FIG. 1. The lower end face 42 includes the negative electrode edge part 222E, of the negative electrode exposed region 222, that is bent toward the through hole 26 in a wound state.

In the stacked body S20 in the electrode wound body 20, the positive electrode 21 and the negative electrode 22 are so stacked with the separator 23 interposed therebetween that the positive electrode exposed region 212 and the first part 222A of the negative electrode exposed region 222 face toward mutually opposite directions along the W direction, i.e., a width direction. In the electrode wound body 20, an end part of the separator 23 is fixed by attaching a fixing tape 46 to a side surface part 45 of the electrode wound body 20, which prevents loosening of winding.

In the secondary battery 1, as illustrated in FIG. 2, A>B may be satisfied, where A is a width of the positive electrode exposed region 212, and B is a width of the first part 222A of the negative electrode exposed region 222. For example, when the width A is 7 (mm), the width B is 4 (mm). Further, C>D may be satisfied, where C is a width of a part of the positive electrode exposed region 212 protruding from an outer edge in the width direction of the separator 23, and D is a width of a part of the first part 222A of the negative electrode exposed region 222 protruding from an opposite outer edge in the width direction of the separator 23. For example, when the width C is 4.5 (mm), the width D is 3 (mm).

As illustrated in FIG. 1, in the upper part of the secondary battery 1, multiple parts, of the positive electrode edge part 212E of the positive electrode exposed region 212 wound around the central axis CL, that are adjacent to each other in a radial direction (an R direction) of the electrode wound body 20 are so bent toward the central axis CL as to overlap each other to thereby form the upper end face 41 of the electrode wound body 20. Similarly, in the lower part of the secondary battery 1, multiple parts, of the negative electrode edge part 222E, of the negative electrode exposed region 222 wound around the central axis CL, that are adjacent to each other in the radial direction (the R direction) are so bent toward the central axis CL as to overlap each other to thereby form the lower end face 42 of the electrode wound body 20. Accordingly, the multiple parts of the positive electrode edge part 212E of the positive electrode exposed region 212 gather at the upper end face 41 of the electrode wound body 20, and the multiple parts of the negative electrode edge part 222E of the negative electrode exposed region 222 gather at the lower end face 42 of the electrode wound body 20. To achieve better contact between the positive electrode current collector plate 24 that is provided for extracting a current and the positive electrode edge part 212E, the multiple parts of the positive electrode edge part 212E that are bent toward the central axis CL form a flat surface. Similarly, to achieve better contact between the negative electrode current collector plate 25 that is provided for extracting a current and the negative electrode edge part 222E, the multiple parts of the negative electrode edge part 222E that are bent toward the central axis CL form a flat surface. Note that as used herein, the term “flat surface” encompasses not only a completely flat surface but also a surface having some asperities or surface roughness to the extent that joining of the positive electrode exposed region 212 to the positive electrode current collector plate 24 and joining of the negative electrode exposed region 222 to the negative electrode current collector plate 25 are possible.

The positive electrode current collector 21A includes, for example, an aluminum foil, as described above. In contrast, the negative electrode current collector 22A includes, for example, a copper foil, as will be described later. In this case, the positive electrode current collector 21A is softer than the negative electrode current collector 22A. In other words, the positive electrode exposed region 212 has a Young's modulus lower than a Young's modulus of the negative electrode exposed region 222. Accordingly, in an embodiment, it is more preferable that the widths A to D satisfy a relationship of A>B and C>D. In such a case, when the positive electrode exposed region 212 and the negative electrode exposed region 222 are simultaneously bent with equal pressures from respective electrode sides, the bent portion in the positive electrode 21 and the bent portion in the negative electrode 22 may sometimes have substantially equal heights measured from respective ends of the separator 23. In this case, the multiple parts of the positive electrode edge part 212E (FIG. 1) of the positive electrode exposed region 212 appropriately overlap each other by being bent. This allows for easy joining of the positive electrode exposed region 212 and the positive electrode current collector plate 24 to each other. Similarly, the multiple parts of the negative electrode edge part 222E (FIG. 1) of the negative electrode exposed region 222 appropriately overlap each other by being bent. This allows for easy joining of the negative electrode exposed region 222 and the negative electrode current collector plate 25 to each other. As used herein, the term “joining” refers to coupling by, for example, laser welding; however, a method of joining is not limited to the laser welding.

As illustrated in FIG. 2, a part, of the positive electrode exposed region 212 of the positive electrode 21, that is opposed to the negative electrode 22 with the separator 23 interposed therebetween is covered with the insulating layer 101. The insulating layer 101 has a width of 3 mm in the W direction, for example. The insulating layer 101 entirely covers a part of the positive electrode exposed region 212 of the positive electrode 21, that is opposed to the negative electrode covered region 221 of the negative electrode 22 with the separator 23 interposed therebetween. The insulating layer 101 makes it possible to effectively prevent an internal short circuit of the secondary battery 1 when foreign matter enters between the negative electrode covered region 221 and the positive electrode exposed region 212, for example. Further, when the secondary battery 1 undergoes an impact, the insulating layer 101 absorbs the impact and thereby makes it possible to effectively prevent bending of the positive electrode exposed region 212 and a short circuit between the positive electrode exposed region 212 and the negative electrode 22.

The secondary battery 1 may further include insulating tapes 53 and 54 in a gap between the outer package can 11 and the electrode wound body 20. The positive electrode exposed region 212 having portions gathering at the upper end face 41 and the negative electrode exposed region 222 having portions gathering at the lower end face 42 include electrical conductors, such as metal foils, that are exposed. Accordingly, if the positive electrode exposed region 212 and the negative electrode exposed region 222 are in proximity to the outer package can 11, a short circuit between the positive electrode 21 and the negative electrode 22 can occur via the outer package can 11. A short circuit can also occur when the positive electrode current collector plate 24 facing the upper end face 41 and the outer package can 11 come into close proximity to each other. To address this, it is preferable to provide the insulating tapes 53 and 54 as insulating members. Each of the insulating tapes 53 and 54 is an adhesive tape including a base layer, and an adhesive layer provided on one surface of the base layer. The base layer includes, for example, any of polypropylene, polyethylene terephthalate, or polyimide. To prevent the provision of the insulating tapes 53 and 54 from resulting in a decreased capacity of the electrode wound body 20, the insulating tapes 53 and 54 are disposed not to overlap the fixing tape 46 attached to the side surface part 45, and each have a thickness set to be less than or equal to a thickness of the fixing tape 46.

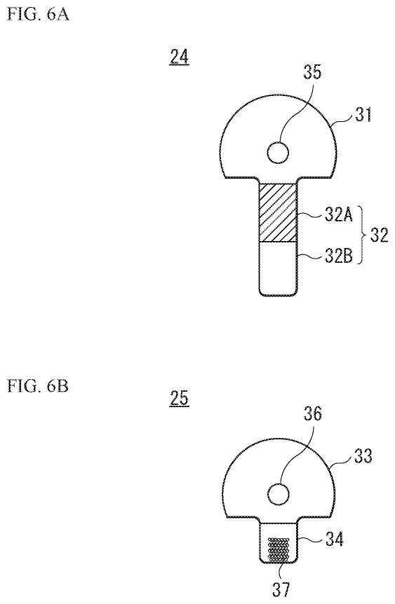

In a typical lithium-ion secondary battery, for example, a lead for current extraction is welded to one location on each of the positive electrode and the negative electrode. However, such a structure increases the internal resistance of the lithium-ion secondary battery and causes the lithium-ion secondary battery to generate heat and become hot upon discharging; therefore, the structure is unsuitable for high-rate discharging. To address this, in the secondary battery 1 according to the present embodiment, the positive electrode current collector plate 24 is disposed to face the upper end face 41, and the negative electrode current collector plate 25 is disposed to face the lower end face 42. In addition, the positive electrode exposed region 212 present at the upper end face 41 and the positive electrode current collector plate 24 are welded to each other at multiple points; and the negative electrode exposed region 222 present at the lower end face 42 and the negative electrode current collector plate 25 are welded to each other at multiple points. A reduced internal resistance of the secondary battery 1 is thereby achieved. Each of the upper end face 41 and the lower end face 42 being a flat surface as described above also contributes to the reduced resistance. The positive electrode current collector plate 24 is disposed between the battery cover 14 and the upper end face 41. The positive electrode current collector plate 24 is electrically coupled to the battery cover 14 via the safety valve mechanism 30, for example. The negative electrode current collector plate 25 is disposed between the bottom part 11B of the outer package can 11 and the lower end face 42. The negative electrode current collector plate 25 is electrically coupled to an inner surface of the bottom part 11B of the outer package can 11, for example. FIG. 6A is a developed diagram illustrating a configuration example of the positive electrode current collector plate 24. FIG. 6B is a developed diagram illustrating a configuration example of the negative electrode current collector plate 25. The positive electrode current collector plate 24 is a metal plate including, for example, aluminum or an aluminum alloy as a single component, or a composite material of aluminum and the aluminum alloy. The negative electrode current collector plate 25 is a metal plate including, for example, nickel, a nickel alloy, copper, or a copper alloy as a single component, or a composite material of two or more thereof.

As illustrated in FIG. 6A, the positive electrode current collector plate 24 includes a fan-shaped part 31 and a band-shaped part 32. The fan-shaped part 31 has a substantially fan shape. The band-shaped part 32 has a substantially rectangular shape. A shape of the positive electrode current collector plate 24 is, however, not limited to the shape illustrated in FIG. 6A, and may be chosen as desired. Note that in the secondary battery 1, the positive electrode current collector plate 24 is contained inside the outer package can 11, as illustrated in FIG. 1, in a state where the band-shaped part 32 is bent with respect to the fan-shaped part 31. FIG. 6A illustrates the positive electrode current collector plate 24 in an unbent state. The fan-shaped part 31 is a facing part facing and coupled to the upper end face 41. The fan-shaped part 31 has an outer edge including a linear part and a curved part, for example. The fan-shaped part 31 has an opening 35 in the vicinity of a middle thereof. FIG. 6A illustrates an example case where the opening 35 has a circular plan shape in a horizontal plane orthogonal to the Z-axis direction. The band-shaped part 32 is coupled to the linear part of the outer edge of the fan-shaped part 31, for example. The band-shaped part 32 extends in a direction intersecting with the linear part of the fan-shaped part 31. As illustrated in FIG. 1, in the secondary battery 1, the positive electrode current collector plate 24 is so provided as to allow the opening 35 to overlap the through hole 26 in the Z-axis direction. In other words, the opening 35 is positioned to overlap, in the Z-axis direction, a part of the upper end face 41 on the winding center side.

A hatched portion in FIG. 6A indicates an insulating part 32A of the band-shaped part 32. The insulating part 32A is a part of the band-shaped part 32 and has an insulating tape attached thereto or an insulating material applied thereto. Of the band-shaped part 32, a portion below the insulating part 32A is a coupling part 32B to be coupled to a sealing plate that also serves as an external terminal. The sealing plate is electrically continuous with the battery cover 14. Note that when the secondary battery 1 has a battery structure without a metallic center pin in the through hole 26 as illustrated in FIG. 1, there is a low possibility that the band-shaped part 32 will come into contact with a region of a negative electrode potential. In such a case, the positive electrode current collector plate 24 does not have to include the insulating part 32A. When the positive electrode current collector plate 24 does not include the insulating part 32A, it is possible to increase a width of each of the positive electrode 21 and the negative electrode 22 by an amount corresponding to a thickness of the insulating part 32A to thereby increase a charge and discharge capacity.

The negative electrode current collector plate 25 illustrated in FIG. 6B has a shape almost the same as the shape of the positive electrode current collector plate 24 illustrated in FIG. 6A. The negative electrode current collector plate 25 includes a fan-shaped part 33 and a band-shaped part 34. The fan-shaped part 33 has a substantially fan shape. The band-shaped part 34 has a substantially rectangular shape. The shape of the negative electrode current collector plate 25 is, however, not limited to the shape illustrated in FIG. 6B, and may be chosen as desired. Note that in the secondary battery 1, the negative electrode current collector plate 25 is contained inside the outer package can 11, as illustrated in FIG. 1, in a state where the band-shaped part 34 is bent with respect to the fan-shaped part 33. FIG. 6B illustrates the negative electrode current collector plate 25 in an unbent state. The fan-shaped part 33 is a facing part facing and coupled to the lower end face 42. The fan-shaped part 33 has an outer edge including a linear part and a curved part, for example. The band-shaped part 34 is coupled to the linear part of the outer edge of the fan-shaped part 33, for example. The band-shaped part 34 extends in a direction intersecting with the linear part of the fan-shaped part 33. The band-shaped part 34 of the negative electrode current collector plate 25 is shorter than the band-shaped part 32 of the positive electrode current collector plate 24, and includes no portion corresponding to the insulating part 32A of the positive electrode current collector plate 24. The band-shaped part 34 is provided with multiple projections 37 that are depicted as circles. The projections 37 each have a round shape. All or a part of the projections 37 are welded to the bottom part 11B of the outer package can 11. Upon resistance welding, a current is concentrated on the projections 37, causing the projections 37 to melt to cause the band-shaped part 34 to be welded to the bottom part 11B of the outer package can 11. As with the positive electrode current collector plate 24, the negative electrode current collector plate 25 has an opening 36 in the vicinity of a middle of the fan-shaped part 33. In the secondary battery 1, the negative electrode current collector plate 25 is so provided as to allow the opening 36 to overlap the through hole 26 in the Z-axis direction. FIG. 6B illustrates an example case where the opening 36 has a circular plan shape in a horizontal plane orthogonal to the Z-axis direction.

The fan-shaped part 31 of the positive electrode current collector plate 24 covers only a part of the upper end face 41, owing to a plan shape of the fan-shaped part 31. Similarly, the fan-shaped part 33 of the negative electrode current collector plate 25 covers only a part of the lower end face 42, owing to a plan shape of the fan-shaped part 33. Reasons why the fan-shaped part 31 and the fan-shaped part 33 do not respectively cover the entire upper end face 41 and the entire lower end face 42 include the following two reasons, for example. A first reason is to allow the electrolytic solution to smoothly permeate the electrode wound body 20 in assembling the secondary battery 1, for example. In particular, in the secondary battery 1 according to the present embodiment, the positive electrode current collector plate 24 is so provided as to allow the opening 35 to overlap a part of the upper end face 41 on the winding center side in the Z-axis direction. Accordingly, a portion of the positive electrode edge part 212E forming the upper end face 41 is not covered with the fan-shaped part 31 of the positive electrode current collector plate 24 and is exposed from the opening 35. The secondary battery 1 thus has a structure that allows for swifter permeation of the electrolytic solution into the electrode wound body 20. A second reason is to allow a gas generated when the lithium-ion secondary battery comes into an abnormally hot state or an overcharged state to be easily released to the outside.

The negative electrode current collector 22A includes an electrically conductive material such as copper, for example. The negative electrode current collector 22A is a metal foil including, for example, nickel, a nickel alloy, copper, or a copper alloy. A surface of the negative electrode current collector 22A may be roughened. One reason for this is that this improves adherence of the negative electrode active material layer 22B to the negative electrode current collector 22A owing to what is called an anchor effect. In this case, it suffices that the surface of the negative electrode current collector 22A is roughened at least in a region facing the negative electrode active material layer 22B. Examples of a roughening method include a method in which microparticles are formed through an electrolytic treatment. In the electrolytic treatment, the microparticles are formed on the surface of the negative electrode current collector 22A by an electrolytic method in an electrolyzer. This provides the surface of the negative electrode current collector 22A with asperities. A copper foil produced by the electrolytic method is generally called an electrolytic copper foil.

The negative electrode active material layer 22B includes, as a negative electrode active material, any one or more of negative electrode materials which lithium is insertable into and extractable from. Note that the negative electrode active material layer 22B may further include any one or more of other materials. Examples of the other materials include a negative electrode binder and a negative electrode conductor. For example, the negative electrode material is a carbon material. One reason for this is that the carbon material exhibits very little change in crystal structure at the time of insertion and extraction of lithium, and a high energy density is thus obtainable stably. Another reason is that the carbon material also serves as a negative electrode conductor, which allows the negative electrode active material layer 22B to be improved in electrically conductive property. Examples of the carbon material include graphitizable carbon, non-graphitizable carbon, and graphite. Note that spacing of a (002) plane of the non-graphitizable carbon may be 0.37 nm or greater. Spacing of a (002) plane of the graphite may be 0.34 nm or less. More specific examples of the carbon material include pyrolytic carbons, cokes, glassy carbon fibers, an organic polymer compound fired body, activated carbon, and carbon blacks. Examples of the cokes include pitch coke, needle coke, and petroleum coke. The organic polymer compound fired body is a resultant of firing or carbonizing a polymer compound such as a phenol resin or a furan resin at a suitable temperature. Other than the above, the carbon material may be low-crystalline carbon heat-treated at a temperature of about 1000° C. or lower, or may be amorphous carbon. Note that the carbon material may have any of a fibrous shape, a spherical shape, a granular shape, and a flaky shape. In the secondary battery 1, when an open circuit voltage in a fully charged state, that is, a battery voltage is 4.25 V or higher, the amount of extracted lithium per unit mass increases as compared with when the open circuit voltage in the fully charged state is 4.20 V, even with the same positive electrode active material. The amount of the positive electrode active material and the amount of the negative electrode active material are therefore adjusted accordingly. This makes it possible to obtain a high energy density.

The negative electrode active material layer 22B may include, as the negative electrode active material, a silicon-containing material including at least one of silicon, silicon oxide, a carbon-silicon compound, or a silicon alloy. The term “silicon-containing material” is a generic term for a material that includes silicon as a constituent element. Note that the silicon-containing material may include only silicon as the constituent element. One silicon-containing material may be used, or two or more silicon-containing materials may be used. The silicon-containing material is able to form an alloy with lithium, and may be a simple substance of silicon, a silicon alloy, a silicon compound, a mixture of two or more thereof, or a material including one or more phases thereof. Further, the silicon-containing material may be crystalline or amorphous, or may include both a crystalline part and an amorphous part. Note that the simple substance described here refers to a simple substance merely in a general sense. The simple substance may thus include a small amount of impurity. In other words, purity of the simple substance is not limited to 100%. The silicon alloy includes, as one or more constituent elements other than silicon, any one or more of elements including, without limitation, tin, nickel, copper, iron, cobalt, manganese, zinc, indium, silver, titanium, germanium, bismuth, antimony, and chromium, for example. The silicon compound includes, as one or more constituent elements other than silicon, any one or more of elements including, without limitation, carbon and oxygen, for example. Note that the silicon compound may include, as one or more constituent elements other than silicon, any one or more of the series of constituent elements described above in relation to the silicon alloy, for example. Specific examples of the silicon alloy and the silicon compound include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, and SiOᵥ (where 0<v≤2). Note that v may be set within any desired range, and may, for example, fall within the following range: 0.2<v<1.4.

The separator 23 is interposed between the positive electrode 21 and the negative electrode 22. The separator 23 allows lithium ions to pass through and prevents a short circuit of a current caused by contact between the positive electrode 21 and the negative electrode 22. The separator 23 includes, for example, any one or more kinds of porous films each including, for example, a synthetic resin or a ceramic, and may include a stacked film of two or more kinds of porous films. Examples of the synthetic resin include polytetrafluoroethylene, polypropylene, and polyethylene. Note that the separator 23 may include a base that includes a single-layer polyolefin porous film including polyethylene. One reason for this is that a favorable high output characteristic is obtainable as compared with a stacked film. When the first separator member 23A and the second separator member 23B included in the separator 23 each include a single-layer porous film including polyolefin, the porous film may have a thickness of greater than or equal to 10 μm and less than or equal to 15 μm, for example. An internal short circuit is sufficiently avoidable if the single-layer porous film including polyolefin has a thickness of greater than or equal to 10 μm. A more favorable discharge capacity characteristic is achievable if the thickness of the single-layer porous film including polyolefin is less than or equal to 15 μm. Further, the porous film may have a surface density of greater than or equal to 6.3 g/m² and less than or equal to 8.3 g/m², for example. Allowing the single-layer porous film including polyolefin to have a surface density of greater than or equal to 6.3 g/m² makes it possible to sufficiently avoid an internal short circuit. Allowing the single-layer porous film including polyolefin to have a surface density of less than or equal to 8.3 g/m² achieves a more favorable discharge capacity characteristic.

In particular, the separator 23 may include, for example, the porous film as each of the above-described bases, and a polymer compound layer provided on one of or each of two opposite surfaces of each of the base. One reason for this is that adherence of the separator 23 to each of the positive electrode 21 and the negative electrode 22 improves, which suppresses distortion of the electrode wound body 20. As a result, a decomposition reaction of the electrolytic solution is suppressed, and leakage of the electrolytic solution with which the bases are impregnated is also suppressed. This prevents an easy increase in resistance even upon repeated charging and discharging, and also suppresses swelling of the battery. The polymer compound layer includes a polymer compound such as polyvinylidene difluoride, for example. One reason for this is that the polymer compound such as polyvinylidene difluoride has superior physical strength and is electrochemically stable. Note that the polymer compound may be other than polyvinylidene difluoride. To form the polymer compound layer, for example, a solution in which the polymer compound is dissolved in a solvent such as an organic solvent is applied on the base, following which the base is dried. Note that the base may be immersed in the solution and thereafter dried. The polymer compound layer may include any one or more kinds of insulating particles such as inorganic particles, for example. Examples of the kind of the inorganic particles include aluminum oxide and aluminum nitride.

The electrolytic solution includes a solvent and an electrolyte salt. Note that the electrolytic solution may further include any one or more of other materials. Examples of the other materials include an additive. The solvent includes any one or more of nonaqueous solvents including, without limitation, an organic solvent. An electrolytic solution including a nonaqueous solvent is what is called a nonaqueous electrolytic solution. The nonaqueous solvent includes a fluorine compound and a dinitrile compound, for example. The fluorine compound includes, for example, at least one of fluorinated ethylene carbonate, trifluorocarbonate, trifluoroethyl methyl carbonate, a fluorinated carboxylic acid ester, or a fluorine ether. The nonaqueous solvent may further include at least one of nitrile compounds other than the dinitrile compound. Examples of the nitrile compounds other than the dinitrile compound include a mononitrile compound and a trinitrile compound. For example, succinonitrile (SN) is preferable as the dinitrile compound. Note that the dinitrile compound is not limited to succinonitrile, and may be another dinitrile compound such as adiponitrile, for example.

The electrolyte salt includes, for example, any one or more of salts including, without limitation, a lithium salt. Note that the electrolyte salt may include a salt other than the lithium salt, for example. Examples of the salt other than lithium salt include a salt of a light metal other than lithium. Examples of the lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). In particular, the lithium salt may include any one or more of lithium hexafluorophosphate, lithium tetrafluoroborate, lithium perchlorate, or lithium hexafluoroarsenate, and more preferably, lithium hexafluorophosphate. Although not particularly limited, a content of the electrolyte salt may be within a range from 0.3 mol/kg to 3 mol/kg both inclusive with respect to the solvent, in particular. When the electrolytic solution includes LiPF₆ as the electrolyte salt, a concentration of LiPF₆ in the electrolytic solution may be higher than or equal to 1.25 mol/kg and lower than or equal to 1.45 mol/kg. One reason for this is that this makes it possible to prevent cycle deterioration caused by consumption, or decomposition, of the salt at the time of high load rate charging, and thus allows for improvement in high-load cyclability characteristic. When the electrolytic solution further includes LiBF₄ in addition to LiPF₆ as the electrolyte salt, a concentration of LiBF₄ in the electrolytic solution may be higher than or equal to 0.001 wt % and lower than or equal to 0.1 wt %. One reason for this is that this makes it possible to more effectively prevent the cycle deterioration caused by consumption, or decomposition, of the salt at the time of high load rate charging, and thus allows for even further improvement in high-load cyclability characteristic.

In the secondary battery 1 according to the present embodiment, for example, upon charging, lithium ions are extracted from the positive electrode 21, and the extracted lithium ions are inserted into the negative electrode 22 via the electrolytic solution. In the secondary battery 1, for example, upon discharging, lithium ions are extracted from the negative electrode 22, and the extracted lithium ions are inserted into the positive electrode 21 via the electrolytic solution.

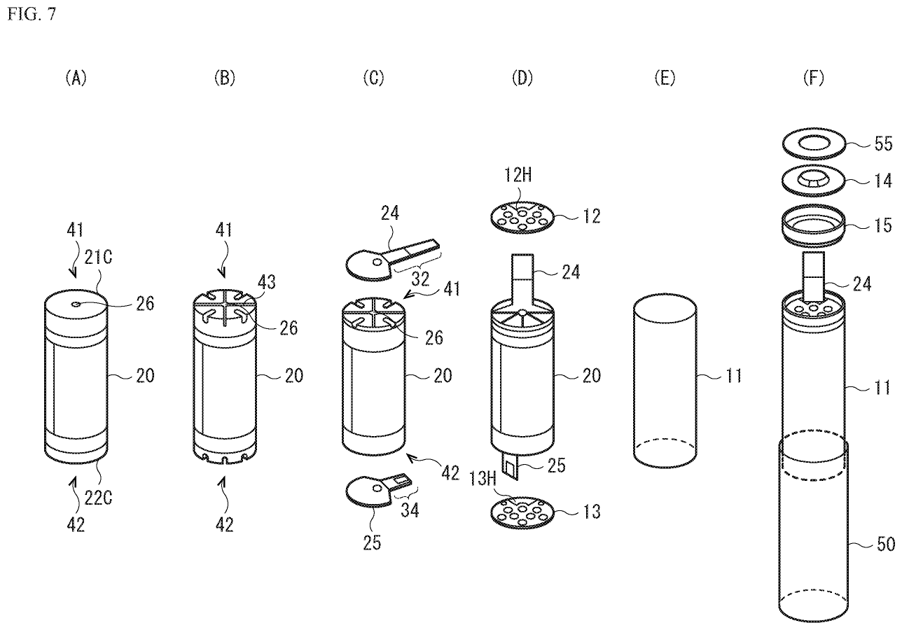

A method of manufacturing the secondary battery 1 will be described with reference to FIG. 7 as well as FIGS. 1 to 6B. FIG. 7 is a perspective diagram describing a process of manufacturing the secondary battery 1 illustrated in FIG. 1.

First, the positive electrode current collector 21A is prepared, and the positive electrode active material layer 21B is selectively formed on the surface of the positive electrode current collector 21A. Thereafter, the insulating layer 101 is formed on the surface of the positive electrode current collector 21A, along the first edge 21BT1 of the positive electrode active material layer 21B. Further, a predetermined region of the positive electrode active material layer 21B is partially removed by, for example, laser ablation. In other words, a part of the positive electrode active material layer 21B in the thickness direction is removed. The thin part 61 is thus formed. Here, performing the laser ablation on the predetermined region of the positive electrode active material layer 21B results in formation of the deactivated part 812 in the positive electrode active material particle 81. The positive electrode 21 is obtained by the above-described operation.

Thereafter, the negative electrode current collector 22A is prepared, and the negative electrode active material layer 22B is selectively formed on the surface of the negative electrode current collector 22A to thereby form the negative electrode 22 including the negative electrode covered region 221 and the negative electrode exposed region 222. The positive electrode 21 and the negative electrode 22 may be subjected to a drying process. Thereafter, the positive electrode 21 and the negative electrode 22 are stacked, with the first separator member 23A and the second separator member 23B on the positive electrode 21 and the negative electrode 22, respectively, to cause the positive electrode exposed region 212 and the first part 222A of the negative electrode exposed region 222 to be on opposite sides to each other in the W direction. The stacked body S20 is thereby fabricated. Thereafter, the stacked body S20 is so wound in a spiral shape as to form the through hole 26. Upon thus winding the stacked body S20, for example, a circular columnar winding core is used as a jig, and the stacked body S20 is wound around the circular columnar winding core. In addition, the fixing tape 46 is attached to an outermost wind of the stacked body S20 wound in the spiral shape, following which the winding core is removed. The electrode wound body 20 is thus obtained as illustrated in part (A) of FIG. 7.

Thereafter, as illustrated in part (B) of FIG. 7, a part of the upper end face 41 and a part of the lower end face 42 of the electrode wound body 20 are each locally bent by pressing an end of, for example, a 0.5-millimeter-thick flat plate against each of the upper end face 41 and the lower end face 42 perpendicularly, that is, in the Z-axis direction. As a result, grooves 43 are formed to extend radiately in the radial directions (the R directions) from the through hole 26. Note that the number and arrangement of the grooves 43 illustrated in part (B) of FIG. 7 are merely an example, and the present disclosure is not limited thereto.

Thereafter, as illustrated in part (C) of FIG. 7, substantially equal pressures are applied to the upper end face 41 and the lower end face 42 in substantially perpendicular directions from above and below the electrode wound body 20 at substantially the same time. At this time, for example, a rod-shaped jig is placed in the through hole 26 in advance. By this operation, the positive electrode exposed region 212 and the first part 222A of the negative electrode exposed region 222 are bent to thereby make each of the upper end face 41 and the lower end face 42 into a flat surface. At this time, the parts, of the positive electrode edge part 212E of the positive electrode exposed region 212 at the upper end face 41, that are adjacent to each other in the radial direction of the electrode wound body 20 may be so bent toward the through hole 26 as to overlap each other. Similarly, the parts, of the negative electrode edge part 222E of the negative electrode exposed region 222 at the lower end face 42, that are adjacent to each other in the radial direction of the electrode wound body 20 may be so bent toward the through hole 26 as to overlap each other. Thereafter, the fan-shaped part 31 of the positive electrode current collector plate 24 is joined to the upper end face 41 by a method such as the laser welding, and the fan-shaped part 33 of the negative electrode current collector plate 25 is joined to the lower end face 42 by a method such as the laser welding.

Thereafter, the insulating tapes 53 and 54 are attached to respective predetermined locations on the electrode wound body 20. Thereafter, as illustrated in part (D) of FIG. 7, the band-shaped part 32 of the positive electrode current collector plate 24 is bent and inserted through a hole 12H of the insulating plate 12. Further, the band-shaped part 34 of the negative electrode current collector plate 25 is bent and inserted through a hole 13H of the insulating plate 13.

Thereafter, the electrode wound body 20 having been assembled in the above-described manner is placed into the outer package can 11 illustrated in part (E) of FIG. 7, following which the bottom part 11B of the outer package can 11 and the negative electrode current collector plate 25 are welded to each other. Thereafter, the narrow part 11S is formed in the vicinity of the open end part 11N of the outer package can 11. Further, the electrolytic solution is injected into the outer package can 11, following which the band-shaped part 32 of the positive electrode current collector plate 24 and the safety valve mechanism 30 are welded to each other.

Thereafter, as illustrated in part (F) of FIG. 7, the outer package can 11 is sealed with the gasket 15, the safety valve mechanism 30, and the battery cover 14, through the use of the narrow part 11S. Lastly, the outer package can 11 with the washer 55 attached on the battery cover 14 is covered with the outer package tube 50, following which the outer package tube 50 is heated by, for example, applying hot air to the outer package tube 50. The outer package tube 50 is thus contracted and closely attached to the outer surface of the outer package can 11. The secondary battery 1 according to the present embodiment is thus completed.

In the secondary battery 1 of the present embodiment, the positive electrode active material layer 21B includes the thin part 61, as described above. This makes it possible to reduce concentration of stress inside the outer package can 11 occurring due to swelling of the negative electrode 22. Specifically, it is possible to suppress, for example, great deformation, such as buckling or bending, of the positive electrode current collector 21A when the negative electrode 22 swells inside the electrode wound body 20 upon charging and discharging. One reason for this is that a reduction in the amount of the electrode reactant, such as lithium ions, supplied to a partial region of the negative electrode active material layer 22B opposed to the thin part 61 suppresses expansion and contraction of the partial region of the negative electrode active material layer 22B opposed to the thin part 61. As a result, stress applied to the separator 23 separating the positive electrode 21 and the negative electrode 22 from each other is also reduced, which makes it possible to avoid breakage of the separator 23 and thereby prevent a short circuit between the positive electrode 21 and the negative electrode 22, even when the separator 23 has a reduced thickness. In other words, it is possible to allow for reduction in the thickness of the separator 23. As a result, it is possible to allow a spacing between the positive electrode 21 and the negative electrode 22 to be reduced, and thereby decrease the internal resistance of the electrode wound body 20. This helps to improve a rate characteristic at a time of charging and discharging and to increase the capacity of the secondary battery 1. In addition, the positive electrode active material layer 21B includes the thick part 71 at the position adjacent to the thin part 61 in the W direction. This makes it possible to allow the separator 23 disposed between the positive electrode active material layer 21B and the negative electrode active material layer 22B to be firmly held. This prevents easy occurrence of winding displacement of the electrode wound body 20 upon expansion and contraction of the electrode wound body 20, and thus makes it possible to prevent the separator 23 from being displaced from a predetermined position. As a result, it is possible to prevent a short circuit between the positive electrode 21 and the negative electrode 22. Accordingly, the secondary battery 1 according to the present embodiment makes it possible to achieve superior reliability.

Further, the positive electrode active material particle 81 is present on the surface, of the thin part 61, on the opposite side to the positive electrode current collector 21A. All or a part of the positive electrode active material particle 81 includes the deactivated part 812. The presence of the deactivated part 812 makes it possible to suppress the electrode reactant, such as lithium ions, from moving from the thin part 61 of the positive electrode active material layer 21B to the negative electrode active material layer 22B. This reduces swelling of the negative electrode 22, and thus makes it possible to effectively reduce concentration of stress inside the outer package can 11 occurring due to the swelling of the negative electrode 22. Accordingly, it is possible to prevent a short circuit between the positive electrode 21 and the negative electrode 22, and to thus achieve superior reliability.

Further, in the secondary battery 1 according to the present embodiment, the position of the border 21B1K in the L direction and the position of the border 21B2K in the L direction are different from each other. More specifically, a position, in the L direction, where a level difference is present in the inner winding side positive electrode active material layer 21B1 and a position, in the L direction, where a level difference is present in the outer winding side positive electrode active material layer 21B2 are different from each other. This allows a location where stress is concentrated in the inward positive electrode current collector surface 21A1 due to swelling of the negative electrode 22 and a location where stress is concentrated in the outward positive electrode current collector surface 21A2 due to the swelling of the negative electrode 22 not to coincide with each other. This disperses stress applied to the positive electrode current collector 21A. Therefore, according to the secondary battery 1 that includes the electrode wound body 20 including the positive electrode 21, it is possible to still further suppress concentration of stress inside the electrode wound body 20 occurring due to expansion and contraction, as compared with when the position of the border 21BIK in the L direction and the position of the border 21B2K in the L direction substantially coincide with each other.

In the secondary battery 1 according to the present embodiment, the thin part 61 includes the winding center side edge 21E1 of the positive electrode 21 in the L direction. In other words, the thin part 61 is provided at a position closest to the winding center in the positive electrode active material layer 21B. This makes it possible to effectively reduce, in the region inside the electrode wound body 20, concentration of stress at and near the center of the electrode wound body 20 where concentration of stress tends to occur markedly easily.

Further, in the secondary battery 1 according to the present embodiment, the thick part 71 is provided between the thin part 61 and the insulating layer 101. This makes it possible to allow the insulating layer 101 to have a sufficient thickness, and to thereby enhance insulating performance of the insulating layer 101. Further, the thick part 71 may be in contact with the insulating layer 101. This makes it possible to prevent easy detachment of the insulating layer 101 from the positive electrode current collector 21A and the positive electrode active material layer 21B.

Further, in the secondary battery 1 according to the present embodiment, the positive electrode active material layer 21B further includes the thick part 72 that includes the second edge 21BT2 positioned on the opposite side to the first edge 21BT1 in the W direction. This makes it possible to allow the separator 23 disposed between the positive electrode active material layer 21B and the negative electrode active material layer 22B to be held more firmly.

Further, in the secondary battery 1 according to the present embodiment, the positive electrode active material layer 21B further includes the thick part 73 provided on the opposite side of the thin part 61 to the winding center side edge 21E1 in the L direction. This helps to obtain a predetermined battery capacity while reducing concentration of stress at and near the winding center of the electrode wound body 20.

Further, in the secondary battery 1 according to the present embodiment, each of the inner winding side positive electrode active material layer 21B1 and the outer winding side positive electrode active material layer 21B2 includes the thin part 61 and the thick parts 71 to 73. This makes it possible to more effectively reduce the concentration of stress at and near the winding center of the electrode wound body 20. Further, in the secondary battery 1 according to the present embodiment, the thin part 61 is provided in a region including a middle of the positive electrode 21 in the W direction, i.e., the width direction of the positive electrode 21. This makes it possible to effectively reduce the concentration of stress inside the electrode wound body 20.

Further, the secondary battery may include a lithium-ion secondary battery. This allows a sufficient battery capacity to be obtained stably through insertion and extraction of lithium, and to thereby makes it possible to achieve higher operation reliability.

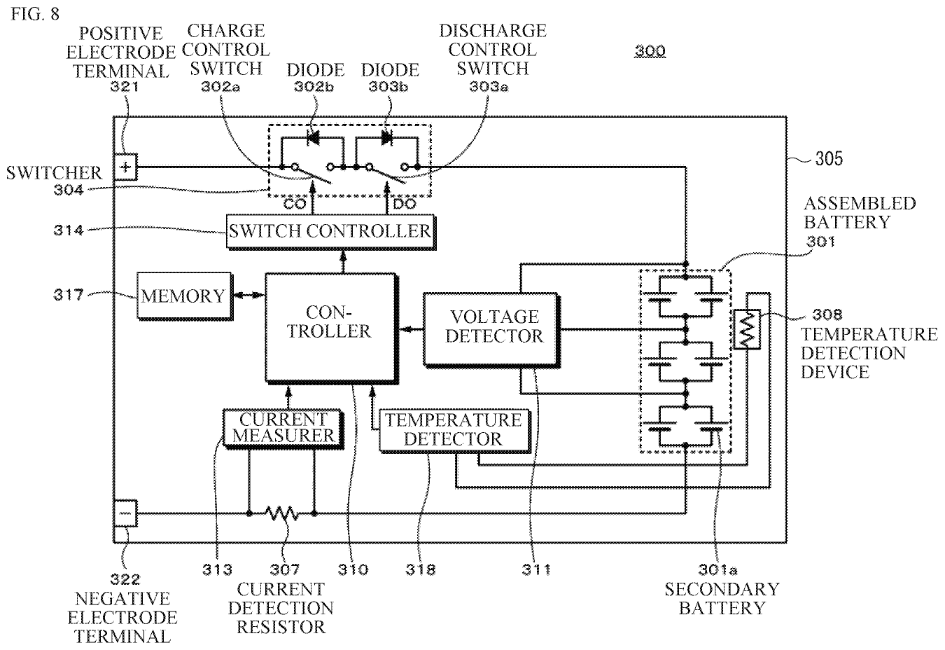

FIG. 8 is a block diagram illustrating a circuit configuration example in which a battery according to an embodiment of the invention, which will hereinafter be referred to as a secondary battery as appropriate, is applied to a battery pack 300. The battery pack 300 includes an assembled battery 301, an outer package body 305, a switcher 304, a current detection resistor 307, a temperature detection device 308, and a controller 310. The outer package body 305 contains the assembled battery 301. The switcher 304 includes a charge control switch 302a and a discharge control switch 303a.

The battery pack 300 includes a positive electrode terminal 321 and a negative electrode terminal 322. Upon charging, the positive electrode terminal 321 and the negative electrode terminal 322 are respectively coupled to a positive electrode terminal and a negative electrode terminal of a charger to thereby perform charging. Upon use of electronic equipment, the positive electrode terminal 321 and the negative electrode terminal 322 are respectively coupled to a positive electrode terminal and a negative electrode terminal of the electronic equipment to thereby perform discharging.

The assembled battery 301 includes multiple secondary batteries 301a coupled in series or in parallel. The secondary battery 1 described above is applicable to each of the secondary batteries 301a. Note that FIG. 8 illustrates an example case in which six secondary batteries 301a are coupled in a two parallel coupling and three series coupling (2P3S) configuration; however, the secondary batteries 301a may be coupled in any other manner such as in any n parallel coupling and m series coupling configuration (where n and m are each an integer).

The switcher 304 includes the charge control switch 302a, a diode 302b, the discharge control switch 303a, and a diode 303b, and is controlled by the controller 310. The diode 302b has a polarity that is in a reverse direction with respect to a charge current flowing in a direction from the positive electrode terminal 321 to the assembled battery 301 and that is in a forward direction with respect to a discharge current flowing in a direction from the negative electrode terminal 322 to the assembled battery 301. The diode 303b has a polarity that is in the forward direction with respect to the charge current and in the reverse direction with respect to the discharge current. Note that although the switcher 304 is provided on a positive side in FIG. 8, the switcher 304 may be provided on a negative side.

The charge control switch 302a is so controlled by a charge and discharge controller that when a battery voltage reaches an overcharge detection voltage, the charge control switch 302a is turned off to thereby prevent the charge current from flowing through a current path of the assembled battery 301. After the charge control switch 302a is turned off, only discharging is enabled through the diode 302b. Further, the charge control switch 302a is so controlled by the controller 310 that when a large current flows upon charging, the charge control switch 302a is turned off to thereby block the charge current flowing through the current path of the assembled battery 301. The discharge control switch 303a is so controlled by the controller 310 that when the battery voltage reaches an overdischarge detection voltage, the discharge control switch 303a is turned off to thereby prevent the discharge current from flowing through the current path of the assembled battery 301. After the discharge control switch 303a is turned off, only charging is enabled through the diode 303b. Further, the discharge control switch 303a is so controlled by the controller 310 that when a large current flows upon discharging, the discharge control switch 303a is turned off to thereby block the discharge current flowing through the current path of the assembled battery 301.

The temperature detection device 308 is, for example, a thermistor. The temperature detection device 308 is provided in the vicinity of the assembled battery 301, measures a temperature of the assembled battery 301, and supplies data of the measured temperature to the controller 310. A voltage detector 311 measures a voltage of the assembled battery 301 and a voltage of each of the secondary batteries 301a included in the assembled battery 301, performs A/D conversion on data of the measured voltages, and supplies the converted data to the controller 310. A current measurer 313 measures a current by using the current detection resistor 307, and supplies data of the measured current to the controller 310. A switch controller 314 controls the charge control switch 302a and the discharge control switch 303a of the switcher 304, based on the data of the voltages inputted from the voltage detector 311 and the data of the current inputted from the current measurer 313.

When a voltage of any of the multiple secondary batteries 301a reaches the overcharge detection voltage or below, or reaches the overdischarge detection voltage or below, or when a large current flows suddenly, the switch controller 314 transmits a control signal to the switcher 304 to thereby prevent overcharging and overdischarging, and overcurrent charging and discharging. Here, for example, when the secondary battery is a lithium-ion secondary battery, the overcharge detection voltage is determined to be, for example, 4.20 V=0.05 V, and the overdischarge detection voltage is determined to be, for example, 2.4 V=0.1 V.

As the charge and discharge control switches, for example, semiconductor switches such as MOSFETs are usable. In this case, parasitic diodes of the MOSFETs serve as the diodes 302b and 303b. When P-channel FETs are used as the charge and discharge control switches, the switch controller 314 supplies control signals DO and CO to a gate of the charge control switch 302a and a gate of the discharge control switch 303a, respectively. When the charge control switch 302a and the discharge control switch 303a are of P-channel type, the charge control switch 302a and the discharge control switch 303a are turned on by a gate potential that is lower than a source potential by a predetermined value or more. In other words, in normal charging and discharging operations, the control signals CO and DO are set to a low level to turn on the charge control switch 302a and the discharge control switch 303a.

For example, upon overcharging or overdischarging, the control signals CO and DO are set to a high level to turn off the charge control switch 302a and the discharge control switch 303a.

A memory 317 includes a RAM and a ROM. For example, the memory 317 includes an erasable programmable read only memory (EPROM) as a nonvolatile memory. In the memory 317, values including, without limitation, numerical values calculated by the controller 310 and a battery's internal resistance value of each of the secondary batteries 301a in an initial state measured in the manufacturing process stage, are stored in advance and are rewritable on an as-needed basis. Further, by storing a full charge capacity of the secondary battery 301a in the memory 317, the controller 310 is able to calculate, for example, a remaining capacity.

A temperature detector 318 measures a temperature by using the temperature detection device 308, performs charge and discharge control upon abnormal heat generation, and performs correction in calculating the remaining capacity.

The secondary battery according to the foregoing embodiment of the present disclosure is mountable on, or usable to supply electric power to, for example, any of equipment including, without limitation, electronic equipment, an electric vehicle, an electric aircraft, and an electric power storage apparatus.

Examples of the electronic equipment include laptop personal computers, smartphones, tablet terminals, PDAs as mobile information terminals, mobile phones, wearable terminals, cordless phone handsets, hand-held video recording and playback devices, digital still cameras, electronic books, electronic dictionaries, music players, radios, headphones, game machines, navigation systems, memory cards, pacemakers, hearing aids, electric tools, electric shavers, refrigerators, air conditioners, televisions, stereos, water heaters, microwave ovens, dishwashers, washing machines, dryers, lighting equipment, toys, medical equipment, robots, road conditioners, and traffic lights.

Examples of the electric vehicle include railway vehicles, golf carts, electric carts, and electric automobiles including hybrid electric automobiles. The secondary battery is usable as a driving power source or an auxiliary power source for any of these electric vehicles. Examples of the electric power storage apparatuses include an electric power storage power source for architectural structures including residential houses, or for power generation facilities.

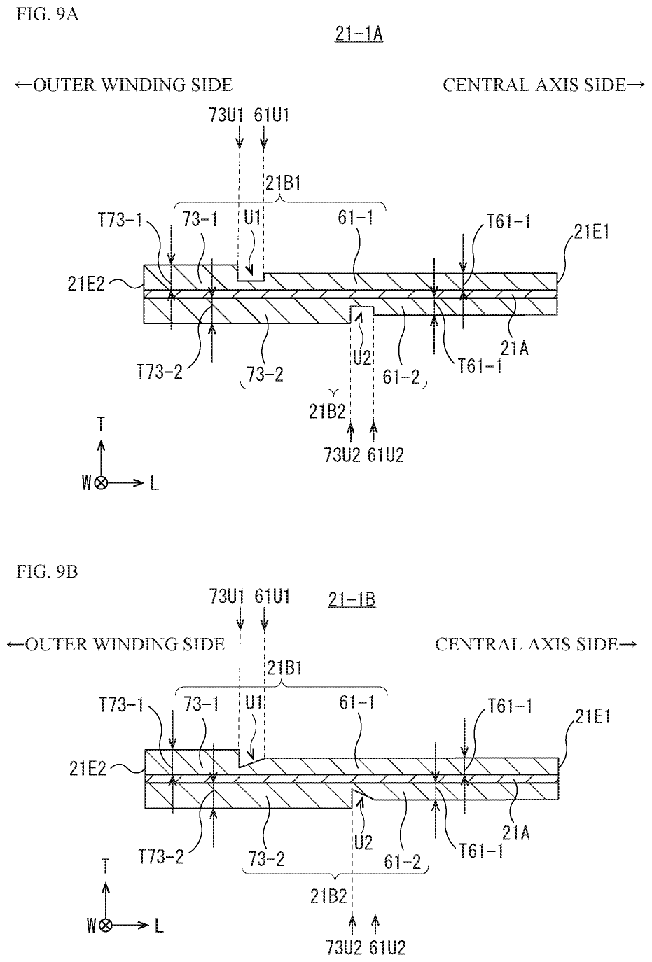

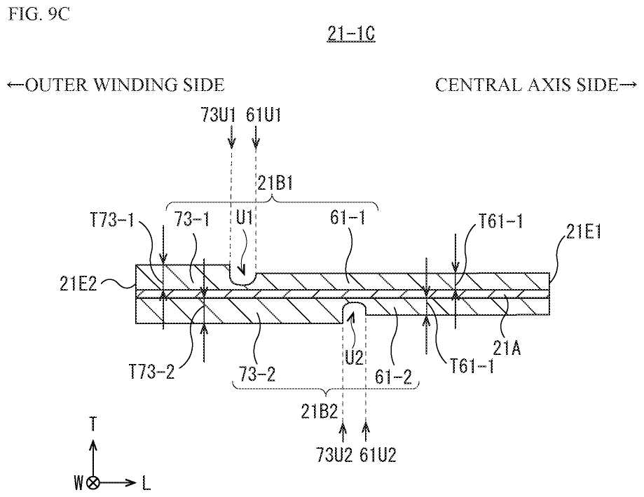

Next, a description is given of a positive electrode 21-1 according to a first modification example, i.e., each of positive electrodes 21-1A to 21-1C. The positive electrode 21-1, i.e., each of the positive electrodes 21-1A to 21-1C, is to be applied to the secondary battery 1 according to the present embodiment described above. FIGS. 9A to 9C respectively illustrate sectional configurations of the positive electrodes 21-1A to 21-1C and each correspond to FIG. 4C illustrating the positive electrode 21 according to the embodiment described above.

As illustrated in corresponding one of FIGS. 9A to 9C, in each of the positive electrodes 21-1A to 21-1C according to the first modification example, the inner winding side positive electrode active material layer 21B1 further includes a grooved part U1 between the thick part 73-1 and the thin part 61-1, and the outer winding side positive electrode active material layer 21B2 further includes a grooved part U2 between the thick part 73-2 and the thin part 61-2. The grooved parts U1 and U2 each extend in the W direction. The grooved part U1 has a thickness still smaller than the thickness T61-1 of the thin part 61-1 in the inner winding side positive electrode active material layer 21B1. Similarly, the grooved part U2 has a thickness still smaller than the thickness T61-2 of the thin part 61-2 in the outer winding side positive electrode active material layer 21B2. Note that in the positive electrode 21-1A illustrated in FIG. 9A, the grooved parts U1 and U2 each have a substantially rectangular sectional shape. In the positive electrode 21-1B illustrated in FIG. 9B, the grooved parts U1 and U2 each have a substantially V-shaped sectional shape. In the positive electrode 21-1C illustrated in FIG. 9C, the grooved parts U1 and U2 each have a substantially U-shaped sectional shape. However, the sectional shape of each of the grooved parts U1 and U2 is not limited to the shape illustrated in each of FIGS. 9A and 9C, and may be chosen as desired.

In each of the positive electrodes 21-2A to 21-2C, a width of the grooved part U1 and a width of the grooved part U2 may be the same as each other in the L direction, or may be different from each other in the L direction. More specifically, the width of the grooved part U1 and the width of the grooved part U2 may be equal to each other, or may be different from each other. The width of the grooved part U1 refers to a length in the L direction from a position of a border 73U1 between the thick part 73-1 and the grooved part U1 to a position of a border 61U1 between the thin part 61 and the grooved part U1. The width of the grooved part U2 refers to a length in the L direction from a position of a border 73U2 between the thick part 73-2 and the grooved part U2 to a position of a border 61U2 between the thin part 61-2 and the grooved part U2. Each of the width of the grooved part U1 and the width of the grooved part U2 is about 150 μm, for example.

In the configuration example of each of the positive electrodes 21-1A to 21-1C respectively illustrated in FIGS. 9A to 9C, the position of the border 73U1 in the L direction and the position of the border 73U2 in the L direction are different from each other, and the position of the border 61U1 in the L direction and the position of the border 61U2 in the L direction are different from each other. However, in the present disclosure, the position of the border 73U1 in the L direction and the position of the border 73U2 in the L direction may coincide with each other. Alternatively, the position of the border 61U1 in the L direction and the position of the border 61U2 in the L direction may coincide with each other.

Note that in the configuration example of each of the positive electrodes 21-1A to 21-1C respectively illustrated in FIGS. 9A to 9C, the inner winding side positive electrode active material layer 21B1 includes the grooved part U1, and the outer winding side positive electrode active material layer 21B2 includes the grooved part U2. However, only either the grooved part U1 or the grooved part U2 may be provided.

As described above, each of the positive electrodes 21-1A to 21-1C according to the first modification example includes the grooved part U1, the grooved part U2, or both. When any of the positive electrodes 21-1A to 21-1C is included in the secondary battery 1, this makes it possible to allow the separator 23 to be held more firmly between relevant one of the positive electrodes 21-1A to 21-1C and the negative electrode 22. One reason for this is that the separator 23 being partly received in the grooved part U1, the grooved part U2, or both helps to prevent the separator 23 interposed between the relevant one of the positive electrodes 21-1A to 21-1C and the negative electrode 22 from being easily displaced or detached from the predetermined position. As a result, in the secondary battery 1 including any of the positive electrodes 21-1A to 21-1C, it is possible to effectively prevent a short circuit between the relevant one of the positive electrodes 21-1A to 21-1C and the negative electrode 22, and to thereby achieve further superior reliability.

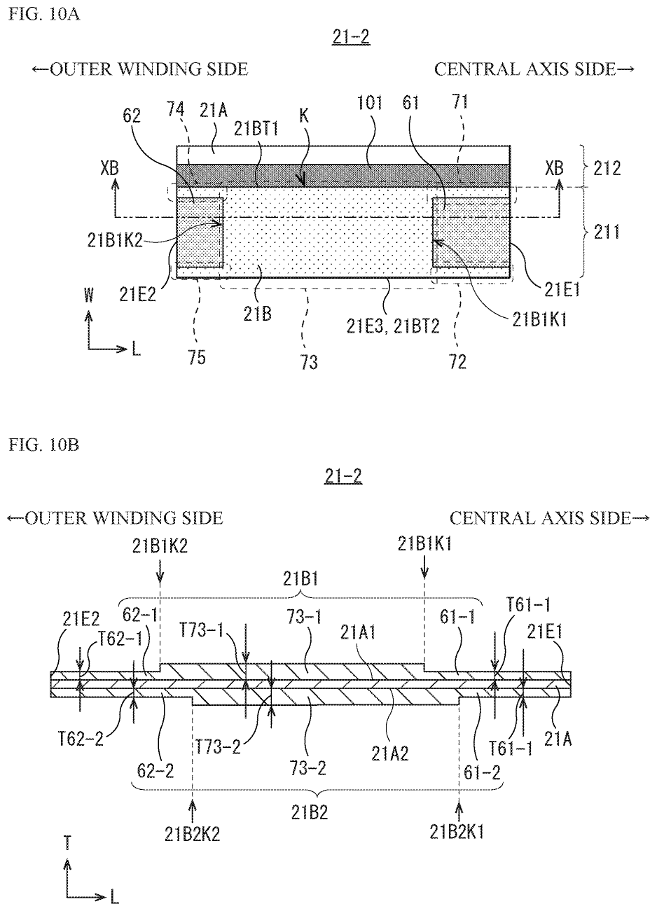

Next, referring to FIGS. 10A and 10B, a description is given of a positive electrode 21-2 according to a second modification example. The positive electrode 21-2 is to be applied to the secondary battery 1 according to the embodiment described above. FIG. 10A is a developed view of the positive electrode 21-2 and corresponds to FIG. 4A illustrating the positive electrode 21 according to the embodiment described above. FIG. 10B is a developed view of the positive electrode 21-2 and corresponds to FIG. 4C illustrating the positive electrode 21 according to the embodiment described above. Note that FIG. 10B illustrates a section as viewed in an arrowed direction along a line XB-XB illustrated in FIG. 10A.

As illustrated in FIGS. 10A and 10B, in the positive electrode 21-2, the positive electrode active material layer 21B further includes a thin part 62. The thin part 62 is provided on an opposite side of the thick part 73 to the thin part 61. The thin part 62 has a thickness smaller than the thickness of the thick part 73. The thin part 62 includes the winding outer periphery side edge 21E2 of the positive electrode 21-2 in the L direction. The thin part 62 has a length in the L direction that may correspond to, for example, about a half wind or less of the electrode wound body 20 from the winding outer periphery side edge 21E2. The positive electrode active material layer 21B further includes a thick part 74 adjacent to the thin part 62 in the W direction. More specifically, the thick part 74 is positioned between the thin part 62 and the insulating layer 101 in the W direction. The thick part 74 may include the first edge 21BT1 and may be in contact with the insulating layer 101. The positive electrode active material layer 21B further includes a thick part 75. The thick part 75 includes the second edge 21BT2.

In the positive electrode 21-2 according to the second modification example, the thin part 62 is provided on each of the inward positive electrode current collector surface 21A1 and the outward positive electrode current collector surface 21A2. In other words, each of the inner winding side positive electrode active material layer 21B1 and the outer winding side positive electrode active material layer 21B2 includes the thin part 62. Note that, for convenience, in FIG. 10B, the thin part 62 included in the inner winding side positive electrode active material layer 21B1 is denoted as a thin part 62-1; and the thin part 62 included in the outer winding side positive electrode active material layer 21B2 is denoted as a thin part 62-2. As illustrated in FIG. 10B, in the positive electrode 21-2, a position of a border 21B1K1 between the thin part 61-1 and the thick part 73-1 in the L direction is different from a position of a border 21B2K1 between the thin part 61-2 and the thick part 73-2 in the L direction. Further, in the positive electrode 21-2, a position of a border 21B1K2 between the thin part 62-1 and the thick part 73-1 in the L direction is different from a position of a border 21B2K2 between the thin part 62-2 and the thick part 73-2 in the L direction.

As described above, in the positive electrode 21-2 according to the second modification example includes, in addition to the thin part 61, the thin part 62 provided on the winding outer periphery side of the electrode wound body 20. This makes it possible to reduce, on the winding outer periphery side of the electrode wound body 20, a level difference between a region where the positive electrode 21 is present and a region where no positive electrode 21 is present, as compared with when the positive electrode 21 with no thin part 62 is used. This helps to reduce concentration of stress at a location, of the separator 23, that overlaps the winding outer periphery side edge 21E2. Accordingly, it is possible to avoid breakage of the separator 23 and thereby prevent a short circuit between the positive electrode 21 and the negative electrode 22, even when the separator 23 has a reduced thickness. In other words, it is possible to reduce the thickness of the separator 23. As a result, it is possible to allow the spacing between the positive electrode 21 and the negative electrode 22 to be reduced, and thereby decrease the internal resistance of the electrode wound body 20. This helps to improve the rate characteristic at the time of charging and discharging and to increase the capacity of the secondary battery 1.

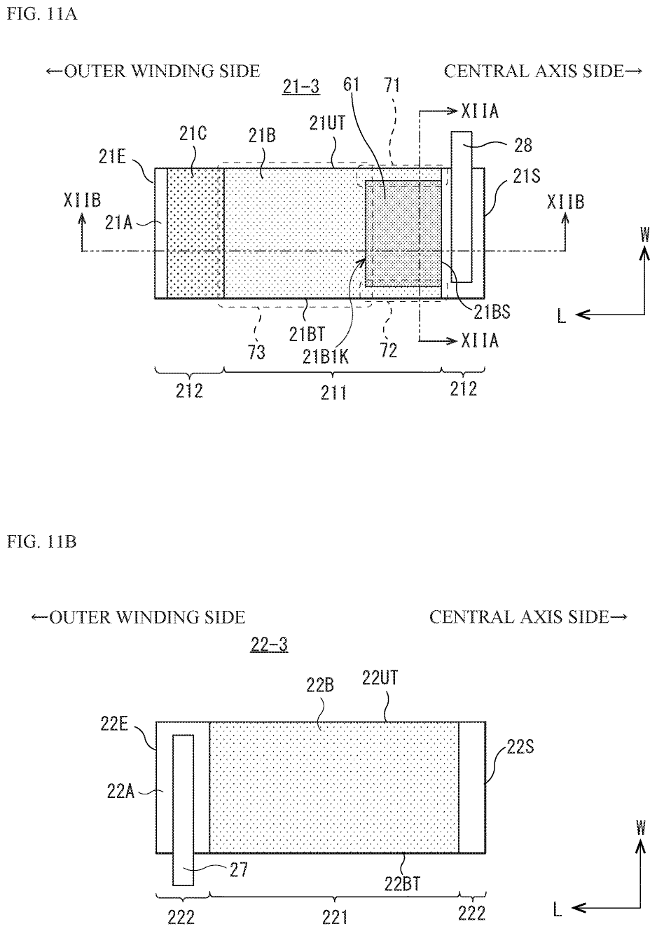

Next, referring to FIGS. 11A and 11B, a description is given of a positive electrode 21-3 and a negative electrode 22-3 according to a third modification example to be applied to the secondary battery 1 according to the embodiment described above. FIG. 11A is a developed view of the positive electrode 21-3 and corresponds to FIG. 4A illustrating the positive electrode 21 according to the embodiment described above. FIG. 11B is a developed view of the negative electrode 22-3 and corresponds to FIG. 5A illustrating the negative electrode 22 according to the embodiment described above. The description above of the embodiment refers to the example where the secondary battery 1 includes the positive electrode 21 and the negative electrode 22 of what is called a tabless structure; however, the present disclosure is not limited thereto. The secondary battery of the present disclosure may include the positive electrode 21-3 that has a tab structure including a positive electrode lead 28 illustrated in FIG. 11A and the negative electrode 22-3 that has a tab structure including a negative electrode lead 27 illustrated in FIG. 11B.

The positive electrode 21-3 includes, as illustrated in FIG. 11A, the positive electrode current collector 21A, the positive electrode active material layer 21B, and a protective tape 21C. The positive electrode active material layer 21B covers a part of the surface of the positive electrode current collector 21A. The positive electrode covered region 211 and the positive electrode exposed region 212 each extend from an upper edge 21UT of the positive electrode 21-3 to a lower edge 21BT of the positive electrode 21-3, along the W direction, i.e., the transverse direction of the positive electrode 21-3, as illustrated in FIG. 11A. In addition, two positive electrode exposed regions 212 are provided at two respective opposite end parts of the positive electrode 21-3 in the L direction, i.e., a longitudinal direction of the positive electrode 21-3. One of the two positive electrode exposed regions 212 includes an inner winding side edge 21S of the innermost positive electrode wind part 21 in (FIG. 3) of the positive electrode 21, and another of the two positive electrode exposed regions 212 includes an outer winding side edge 21E of the outermost positive electrode wind part 21out (FIG. 3) of the positive electrode 21. The positive electrode covered region 211 is interposed between the two positive electrode exposed regions 212 in the L direction. In other words, the positive electrode active material layer 21B is absent at each of the opposite end parts of the positive electrode current collector 21A in the L direction, i.e., the longitudinal direction of the positive electrode current collector 21A. The protective tape 21C is provided on a part of the positive electrode exposed region 212. More specifically, the protective tape 21C covers a part, of the positive electrode current collector 21A in the positive electrode exposed region 212, that is opposed to the negative electrode active material layer 22B. Note that in the configuration example illustrated in FIG. 11A, the protective tape 21C is provided on the positive electrode exposed region 212 on the outer winding side, of the two positive electrode exposed regions 212; however, the protective tape 21C may be provided also on the positive electrode exposed region 212 on the inner winding side, of the two positive electrode exposed regions 212. The positive electrode lead 28 is attached to the positive electrode current collector 21A in the positive electrode exposed region 212 on the inner winding side.

The protective tape 21C may be adhered to the separator 23. One reason for this is that this makes it possible to prevent the positive electrode 21 and the separator 23 from becoming misaligned with each other. The protective tape 21C may include a material that does not swell. One reason for this is that this makes it possible to prevent the negative electrode from being damaged due to swelling. The protective tape 21C may include a resin including polyimide (PI), for example.

The negative electrode 22-3 includes, as illustrated in FIG. 11B, the negative electrode current collector 22A and the negative electrode active material layer 22B. The negative electrode active material layer 22B is provided on each of the two opposite surfaces of the negative electrode current collector 22A. The negative electrode 22-3 includes the negative electrode covered region 221 and the negative electrode exposed region 222. The negative electrode covered region 221 and the negative electrode exposed region 222 each extend from an upper edge 22UT of the negative electrode 22 to a lower edge 22BT of the negative electrode 22, along the W direction, i.e., a transverse direction of the negative electrode 22-3, as illustrated in FIG. 11B. Further, two negative electrode exposed regions 222 are provided at two respective opposite end parts of the negative electrode 22 in the L direction, i.e., the longitudinal direction of the negative electrode 22. One of the two negative electrode exposed regions 222 includes an inner winding side edge 22S of the innermost negative electrode wind part 22 in (FIG. 2) of the negative electrode 22, and another of the two negative electrode exposed regions 222 includes the outer winding side edge 22E of the outermost negative electrode wind part 22out (FIG. 2) of the negative electrode 22. The negative electrode covered region 221 is interposed between the two negative electrode exposed regions 222 in the L direction. In other words, the negative electrode active material layer 22B is absent at each of the opposite end parts of the negative electrode current collector 22A in the L direction, i.e., the longitudinal direction of the negative electrode current collector 22A. Note that a size and a position of a region of the negative electrode active material layer 22B covering the outward negative electrode current collector surface 22A2 and a size and a position of a region of the negative electrode active material layer 22B covering the inward negative electrode current collector surface 22A1 may be different from each other, or may coincide with each other.

The negative electrode lead 27 is attached to the negative electrode current collector 22A in the negative electrode exposed region 222. More specifically, the negative electrode lead 27 is attached to the negative electrode current collector 22A in the negative electrode exposed region 222 on the outer winding side, of the two negative electrode exposed regions 222. The negative electrode lead 27 is so provided that a part of the negative electrode lead 27 protrudes downward from the lower edge 22BT of the negative electrode 22.

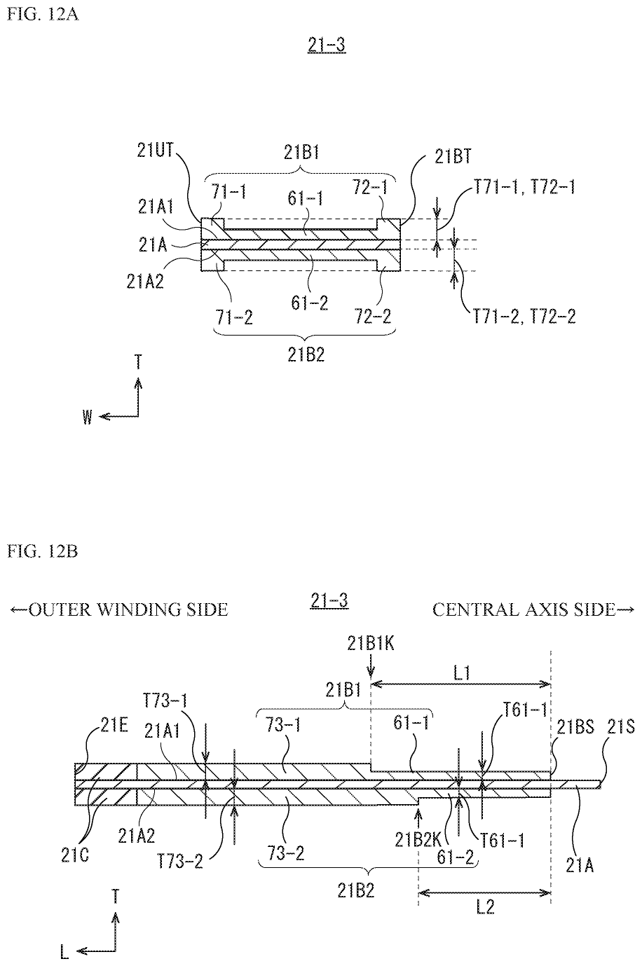

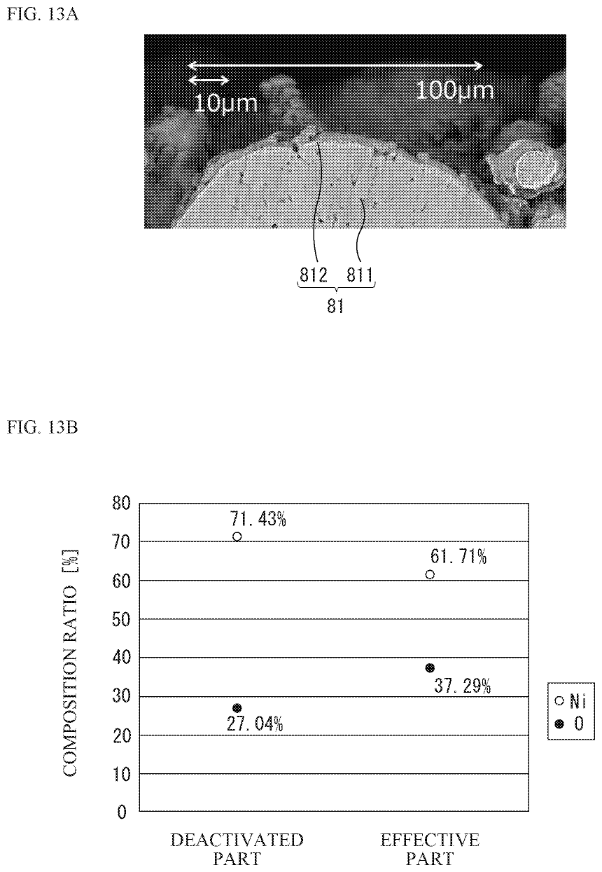

FIGS. 12A and 12B each illustrate a sectional configuration of the positive electrode 21-3. FIG. 12A illustrates a section as viewed in an arrowed direction along line XIIA-XIIA illustrated in FIG. 11A. FIG. 12B illustrates a section as viewed in an arrowed direction along line XIIB-XIIB illustrated in FIG. 11A.

The positive electrode active material layer 21B includes the thin part 61 and the thick parts 71 to 73. In the positive electrode 21 according to the present embodiment, each of the thin part 61 and the thick parts 71 to 73 is provided on each of the inward positive electrode current collector surface 21A1 and the outward positive electrode current collector surface 21A2. In other words, each of the inner winding side positive electrode active material layer 21B1 and the outer winding side positive electrode active material layer 21B2 includes each of the thin part 61 and the thick parts 71 to 73. Note that, for convenience, in FIGS. 12A and 12B, the thin part 61 and the thick parts 71, 72, and 73 included in the inner winding side positive electrode active material layer 21B1 are respectively denoted as the thin part 61-1 and the thick parts 71-1, 72-1, and 73-1. The thin part 61 and the thick parts 71, 72, and 73 included in the outer winding side positive electrode active material layer 21B2 are respectively denoted as the thin part 61-2 and the thick parts 71-2, 72-2, and 73-2, for convenience. In the example illustrated in FIG. 12B, the position of the border 21BIK between the thin part 61-1 and the thick part 73-1 in the L direction is different from the position of the border 21B2K between the thin part 61-2 and the thick part 73-2 in the L direction.

The thin part 61 includes a winding center side edge, i.e., an inner winding side edge 21BS of the positive electrode active material layer 21B in the L direction. The thin part 61 may extend in the L direction, for example, from the inner winding side edge 21BS within a range corresponding to about one wind to about five winds of the electrode wound body 20. The thick part 71 is adjacent to the thin part 61 in the W direction. More specifically, the thick part 71 is positioned between the thin part 61 and the upper edge 21UT in the W direction. The thick part 71 includes the first edge 21BT1. The thick part 72 is positioned on an opposite side of the thin part 61 to the thick part 71 in the W direction. In other words, the thick part 72 is positioned between the lower edge 21BT and the thin part 61. The lower edge 21BT is positioned on the opposite side to the upper edge 21UT in the W direction. The thick part 72 includes the lower edge 21BT. The thick part 73 is provided on an opposite side of the thin part 61 to the inner winding side edge 21S in the L direction. Note that the thick parts 71 to 73 may be separated from each other, or may be partly or entirely integrated with each other.

In the secondary battery including the positive electrode 21-3 and the negative electrode 22-3 according to the third modification example also, the position of the border 21B1K in the L direction and the position of the border 21B2K in the L direction are different from each other. Accordingly, it is expectable that such a secondary battery achieves effects similar to those of the embodiment described above.

### EXAMPLES

Examples of the present disclosure will be described according to an embodiment.

### Example 1

### <Fabrication of Positive Electrode>

As described below, the positive electrode 21 illustrated in FIGS. 4A to 4D, etc. was fabricated.

First, an aluminum foil having a thickness of 10 μm was prepared as the positive electrode current collector 21A. Thereafter, a positive electrode mixture was obtained by mixing a layered lithium oxide as the positive electrode active material, with a positive electrode binder and a conductive additive. The layered lithium oxide included lithium nickel cobalt aluminum oxide (NCA) having a Ni ratio of 85% or greater. The positive electrode binder included polyvinylidene difluoride. The conductive additive included a mixture of carbon black, acetylene black, and Ketjen black. A mixture ratio between the positive electrode active material, the positive electrode binder, and the conductive additive was set to 96.4:2:1.6. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on respective predetermined regions of the two opposite surfaces of the positive electrode current collector 21A by using a coating apparatus, following which the applied positive electrode mixture slurry was dried to thereby form the positive electrode active material layers 21B. A thickness of each of the two positive electrode active material layers 21B formed on the respective two opposite surfaces of the positive electrode current collector 21A was set to 95 μm. Further, a coating material including polyvinylidene difluoride (PVDF) was applied on surfaces of the positive electrode exposed region 212, at respective regions adjacent to the positive electrode covered region 211. The applied coating material was dried to thereby form the insulating layer 101 having a width of 3 mm and a thickness of 8 μm. Thereafter, the positive electrode active material layers 21B were compression-molded by using a roll pressing machine. Further, a part of the predetermined region of the positive electrode active material layer 21B in the thickness direction was selectively removed by the laser ablation to thereby form the thin part 61 including the winding center side edge 21E1. As laser irradiation conditions for the laser ablation, a pulse width was set to 30 nsec, a frequency was set to 270 Hz, and an energy density was set to 2 J/cm², as indicated in Table 1. Further, a laser output was set to 200 W, a scanning speed was set to 3000 mm/sec, and the number of times of scanning was set to one.

| | | | | | | | | | Short-circuit | |
|---|---|---|---|---|---|---|---|---|---|---|
| | | | | | | | | | occurrence rate after | |
| | | | | | | | | | charging and | |
| | | | | Positive electrode | | | Negative electrode | | discharging cycle | |
| | Laser irradiation conditions | | | Deactivated | | | Expansion | Ni | (%) | |
| | Pule | | Energy | part | Thick part | Thin part | contraction | precipitation | Upon | Upon |
| | width | Frequency | density | thickness | thickness | thickness | rate | amount | 4.2-volt | 4.3-volt |
| | (nsec) | (Hz) | (J/cm²) | (μm) | (μm) | (μm) | (%) | (ppm) | charging | charging |
| Example 1 | 30 | 270 | 2 | 0.4 | 95 | 50 | 25 | 200 | 0 | 2 |
| Example 2 | 50 | 160 | 3.5 | 0.6 | 95 | 50 | 24 | 260 | 0 | 0 |
| Example 3 | 80 | 100 | 5.3 | 1.0 | 95 | 50 | 23 | 510 | 0 | 0 |
| Example 4 | 200 | 40 | 13.3 | 2.8 | 95 | 50 | 22 | 920 | 0 | 0 |
| Example 5 | 300 | 25 | 20.0 | 3.5 | 95 | 50 | 21 | 1500 | 0 | 4 |
| Example 6 | 500 | 16 | 35.0 | 4.8 | 95 | 50 | 21 | 2500 | 0 | 6 |
| Comparative | — | — | — | — | 95 | — | — | — | 0 | 16 |
| example 1 | | | | | | | | | | |
| Comparative | 800 | 10 | 55.0 | 6.1 | 95 | 50 | 20 | 4000 | 10 | 8 |
| example 2 | | | | | | | | | | |

The positive electrode 21 fabricated as described above was cut in the thickness direction, i.e., the T direction, to form a section along the thickness direction of the positive electrode active material layer 21B. Observation of the section by using a scanning electron microscope (SEM) “S-4800” available from Hitachi, Ltd. resulted in a section image presented in FIG. 13A. In the section image of FIG. 13A, the positive electrode active material particle 81 including the effective part 811 and the deactivated part 812 was confirmed. Further, the section image obtained by the scanning electron microscope was used to conduct an element analysis by using an energy dispersive X-ray spectroscopy (EDX) apparatus “EMAX” available from HORIBA, Ltd. to determine an abundance rate [%] of a Ni element and an O element in the positive electrode active material layer 21B. In the element analysis by EDX, a measurement mode of the EDX was set to point EDX, an acceleration voltage was set to 5 kV, a magnification was set to 40 K, and the number of times of repetition was set to three. The results are presented in FIG. 13B. As indicated in FIG. 13B, the effective part 811 had an oxygen concentration of 37.29% and a nickel concentration of 61.71%, and the deactivated part 812 had an oxygen concentration of 27.04% and a nickel concentration of 71.43%. Thus, it was confirmed that the oxygen concentration in the deactivated part 812 of the positive electrode active material particle 81 was lower than the oxygen concentration in the effective part 811 of the positive electrode active material particle 81. Further, the thickness of the deactivated part 812 was determined based on the section image of FIG. 13A. Note that the thickness of the deactivated part 812 was determined as an average value of measured values at any five points. The results are presented in Table 1.

Further, the thickness of the thin part 61 of the positive electrode active material layer 21B was determined by observing the section of the positive electrode 21 fabricated as described above, along the thickness direction of the positive electrode 21. Note that the thickness of the thin part 61 was determined as an average value of measured values at any five points. The results are presented in Table 1.

### <Fabrication of Negative Electrode>

Further, the negative electrode 22 illustrated in FIGS. 5A and 5B, etc. was fabricated as described below. Specifically, a copper foil having a thickness of 8 μm was prepared as the negative electrode current collector 22A. Thereafter, a negative electrode mixture was obtained by mixing the negative electrode active material with a negative electrode binder and a conductive additive. The negative electrode active material included a mixture of a carbon material and SiO. The carbon material included graphite. The negative electrode binder included polyvinylidene difluoride. The conductive additive included a mixture of carbon black, acetylene black, and Ketjen black. A mixture ratio between the negative electrode active material, the negative electrode binder, and the conductive additive was set to 96.1:2.9:1.0. Further, a mixture ratio between graphite and SiO in the negative electrode active material was set to 95:5. Thereafter, the negative electrode mixture was put into an organic solvent (N-methyl-2-pyrrolidone), following which the organic solvent was stirred to thereby prepare a negative electrode mixture slurry in paste form. Thereafter, the negative electrode mixture slurry was applied on respective predetermined regions of the two opposite surfaces of the negative electrode current collector 22A by using a coating apparatus, following which the applied negative electrode mixture slurry was dried to thereby form the negative electrode active material layers 22B. Thereafter, the negative electrode active material layers 22B were compression-molded by using a roll pressing machine. The negative electrode 22 including the negative electrode covered region 221 and the negative electrode exposed region 222 was thus obtained. Thereafter, the negative electrode 22 was sheared to make the negative electrode covered region 221 have a width of 62 mm in the W direction, and to make the first part 222A of the negative electrode exposed region 222 have a width of 4 mm in the W direction. Further, the negative electrode 22 was provided with a length in the L direction of 1760 mm. The thickness of each of the two negative electrode active material layers 22B formed on the respective two opposite surfaces of the negative electrode current collector 22A was set to 80 μm.

### <Fabrication of Secondary Battery>

Further, the secondary battery 1 illustrated in FIG. 1, etc. was fabricated using the positive electrode 21 and the negative electrode 22 fabricated as described above. First, the positive electrode 21 and the negative electrode 22 were subjected to a drying process. Thereafter, the positive electrode 21 and the negative electrode 22 were stacked, with the first separator member 23A and the second separator member 23B on the positive electrode 21 and the negative electrode 22, respectively, to cause the positive electrode exposed region 212 and the first part 222A of the negative electrode exposed region 222 to be on opposite sides to each other in the W direction. The stacked body S20 was thereby fabricated. At this time, the stacked body S20 was fabricated not to allow the positive electrode active material layers 21B to protrude from the negative electrode active material layers 22B in the W direction. As each of the first separator member 23A and the second separator member 23B, used was a polyethylene sheet having a width of 65 mm and a thickness of 5 μm. Thereafter, the stacked body S20 was so wound in a spiral shape as to form the through hole 26, and the fixing tape 46 was attached to the outermost wind of the stacked body S20 thus wound.

Thereafter, the upper end face 41 and the lower end face 42 of the electrode wound body 20 were each locally bent by pressing an end of a 0.5-millimeter-thick flat plate against each of the upper end face 41 and the lower end face 42 in the Z-axis direction. The grooves 43 extending radiately in the radial directions (the R directions) from the through hole 26 were thereby formed.

Thereafter, substantially equal pressures were applied to the upper end face 41 and the lower end face 42 in substantially perpendicular directions from above and below the electrode wound body 20 at substantially the same time. The positive electrode exposed region 212 and the first part 222A of the negative electrode exposed region 222 were thereby bent to make each of the upper end face 41 and the lower end face 42 into a flat surface. At this time, the positive electrode edge parts 212E of the positive electrode exposed region 212 positioned at the upper end face 41 were caused to bend toward the through hole 26 while overlapping each other, and the negative electrode edge parts 222E of the negative electrode exposed region 222 positioned at the lower end face 42 were caused to bend toward the through hole 26 while overlapping each other. Thereafter, the fan-shaped part 31 of the positive electrode current collector plate 24 was joined to the upper end face 41 by the laser welding, and the fan-shaped part 33 of the negative electrode current collector plate 25 was joined to the lower end face 42 by the laser welding. Used as the positive electrode current collector plate 24 was a positive electrode current collector plate including the fan-shaped part 31 with the opening 35 having an inner diameter D35 of 4.0 mm.

Thereafter, the insulating tapes 53 and 54 were attached to the predetermined locations on the electrode wound body 20, following which the band-shaped part 32 of the positive electrode current collector plate 24 was bent and inserted through the hole 12H of the insulating plate 12, and the band-shaped part 34 of the negative electrode current collector plate 25 was bent and inserted through the hole 13H of the insulating plate 13. In this case, a flat region 34B, not a projection region 34A, of the band-shaped part 34 was gripped by a predetermined jig and the band-shaped part 34 was bent.

Thereafter, the electrode wound body 20 having been assembled in the above-described manner was placed into the outer package can 11, following which the bottom part 11B of the outer package can 11 and the negative electrode current collector plate 25 were welded to each other. Note that used as the outer package can 11 was an outer package can having an inner diameter D11 of 20.80 mm+0.05 mm.

Thereafter, the narrow part 11S was formed in the vicinity of the open end part 11N of the outer package can 11. Further, the electrolytic solution was injected into the outer package can 11, following which the band-shaped part 32 of the positive electrode current collector plate 24 and the safety valve mechanism 30 were welded to each other.

As the electrolytic solution, used was a solution including a solvent prepared by adding fluoroethylene carbonate (FEC) and succinonitrile (SN) to a major solvent, i.e., ethylene carbonate (EC) and dimethyl carbonate (DMC), and including LiBF₄ and LiPF₆ as an electrolyte salt. In the lithium-ion secondary battery of the present Example, a content ratio (wt %) between EC, DMC, FEC, SN, LiBF₄, and LiPF₆ in the electrolytic solution was set to 12.7:56.2:12.0:1.0:1.0:17.1.

Thereafter, sealing was performed with the gasket 15, the safety valve mechanism 30, and the battery cover 14, through the use of the narrow part 11S. Thereafter, the outer package can 11 with the washer 55 attached on the battery cover 14 was covered with the outer package tube 50, following which the outer package tube 50 was heated by applying hot wind to the outer package tube 50. The outer package tube 50 was thus contracted and closely attached to the outer surface of the outer package can 11.

The secondary battery 1 of Example 1 was thus obtained.

### Example 2

The secondary battery 1 of Example 2 was fabricated by a manner similar to that in Example 1, except that, as the laser irradiation conditions for forming the thin part 61 by the laser ablation, the pulse width was set to 50 nsec, the frequency was set to 160 Hz, and the energy density was set to 3.5 J/cm², as indicated in Table 1. The thickness of the deactivated part 812 and the thickness of the thin part 61 in the fabricated positive electrode 21 were as listed in Table 1.

### Example 3

The secondary battery 1 of Example 2 was fabricated by a manner similar to that in Example 1, except that, as the laser irradiation conditions for forming the thin part 61 by the laser ablation, the pulse width was set to 80 nsec, the frequency was set to 100 Hz, and the energy density was set to 5.3 J/cm², as indicated in Table 1. The thickness of the deactivated part 812 and the thickness of the thin part 61 in the fabricated positive electrode 21 were as listed in Table 1.

### Example 4

The secondary battery 1 of Example 2 was fabricated by a manner similar to that in Example 1, except that, as the laser irradiation conditions for forming the thin part 61 by the laser ablation, the pulse width was set to 200 nsec, the frequency was set to 40 Hz, and the energy density was set to 13.3 J/cm², as indicated in Table 1. The thickness of the deactivated part 812 and the thickness of the thin part 61 in the fabricated positive electrode 21 were as listed in Table 1.

### Example 5

The secondary battery 1 of Example 2 was fabricated by a manner similar to that in Example 1, except that, as the laser irradiation conditions for forming the thin part 61 by the laser ablation, the pulse width was set to 300 nsec, the frequency was set to 25 Hz, and the energy density was set to 20.0 J/cm², as indicated in Table 1. The thickness of the deactivated part 812 and the thickness of the thin part 61 in the fabricated positive electrode 21 were as listed in Table 1.

### Example 6

The secondary battery 1 of Example 2 was fabricated by a manner similar to that in Example 1, except that, as the laser irradiation conditions for forming the thin part 61 by the laser ablation, the pulse width was set to 500 nsec, the frequency was set to 16 Hz, and the energy density was set to 35.0 J/cm², as indicated in Table 1. The thickness of the deactivated part 812 and the thickness of the thin part 61 in the fabricated positive electrode 21 were as listed in Table 1.

### Comparative Example 1

A secondary battery of Comparative example 1 was fabricated by a manner similar to that in Example 1, except that formation of the thin part by the laser ablation was not performed and a positive electrode including only the thick part was formed. The fabricated positive electrode included no deactivated part, and the thickness of the thick part was as listed in Table 1.

### Comparative Example 2

The secondary battery 1 of Example 2 was fabricated by a manner similar to that in Example 1, except that, as the laser irradiation conditions for forming the thin part 61 by the laser ablation, the pulse width was set to 800 nsec, the frequency was set to 10 Hz, and the energy density was set to 55.0 J/cm², as indicated in Table 1. The thickness of the deactivated part 812 and the thickness of the thin part 61 in the fabricated positive electrode 21 were as listed in Table 1.

### <Evaluation of Battery Characteristic>

The secondary batteries 1 of Examples 1 to 7 obtained as described above were each subjected to a charging and discharging cycle test and examined in terms of a short-circuit occurrence rate after the charging and discharging cycle test. In addition, each of the secondary batteries 1 after the charging and discharging cycle test was disassembled to take out the negative electrode 22, and a swelling rate and a Ni precipitation amount of the negative electrode 22 were each measured. The results are presented together in Table 1.

Test conditions for the charging and discharging cycle test were as follows.

### <<Cycle Test Conditions>>

(1) Ambient temperature at which the test was performed: 23° C.
(2) Charge conditions: Constant current and constant voltage (CC-CV) charging was performed. Charging was performed with a constant current of 5 A to a voltage of 4.2 V or 4.3 V, and charging was thereafter performed with a constant voltage of 4.2 V or 4.3 V. A cutoff current was set to 100 mA.
(3) Rest time after charging: 60 minutes.
(4) Discharge conditions: Constant current (CC) discharging was performed with a constant current of 30 A. A cutoff voltage was set to 2.5 V. Alternatively, discharging was stopped when a temperature reached 85° C.
(5): Where one cycle included (2) to (4), the cycle was repeatedly performed until the capacity became 50% or less of an initial discharge capacity.

### <<Short-Circuit Occurrence Rate After Charging and Discharging Cycle>>

Each of the secondary batteries 1 was subjected to the cycle test under the above-described test conditions. Thereafter, each of the secondary batteries 1 was stored in an environment at 25° C.±5° C. for one week. After the storage, if the charge voltage had become lower than 4.1 V, it was determined that a short circuit had occurred. The short-circuit occurrence rate was measured for each of a case where the charge voltage was set to 4.2 V and a case where the charge voltage was set to 4.3 V. The number of samples was 50 in each of Examples and Comparative examples.

The Ni precipitation amount was determined by using an inductively coupled plasma (ICP) mass spectrometer.

As indicated in Table 1, when charging was performed with the normal charge voltage of 4.2 V (hereinafter referred to as “upon 4.2-volt charging”), a short circuit after the charging and discharging cycle did not occur in any of the samples in each of Examples 1 to 6. In contrast, in Comparative example 2, the short-circuit occurrence rate upon the 4.2-volt charging was 10%. One possible reason for this was that, in Comparative example 2, the short circuit tended to occur more easily due to the Ni element eluted from the positive electrode active material layer 21B, because the thickness of the deactivated part 812 was 6.1 μm and a great amount of the Ni element precipitated on the surface of the negative electrode 22.

In contrast, when charging was performed with the overcharge voltage of 4.3 V (hereinafter referred to as “upon 4.3-volt charging”), the short circuit after the charging and discharging cycle did not occur in any of the samples in each of Examples 2 to 4, but the short circuit after the charging and discharging cycle occurred in some of the samples in each of Examples 1, 5, and 6. One possible reason why the short circuit occurred in Example 1 was that, in Example 1, because the thickness of the deactivated part 812 was thin as 0.4 μm, action of suppressing movement of lithium ions as the electrode reactant from the thin part 61 to the negative electrode active material layer 22B was weak, as compared with other Examples such as Examples 2 to 4. One possible reason why the short circuit occurred in each of Examples 5 and 6 was that, in each of Examples 5 and 6, the short circuit tended to occur more easily due to the Ni element eluted from the positive electrode active material layer 21B, because a greater amount of the Ni element precipitated on the surface of the negative electrode 22, as compared with Examples such as Examples 2 to 4. However, in each of Examples 1 to 6, the short-circuit occurrence rate after the charging and discharging cycle upon the 4.3-volt charging was suppressed to be lower than the short-circuit occurrence rate after the charging and discharging cycle upon the 4.3-volt charging in each of Comparative examples 1 and 2. Based on the results described above, it was confirmed that it was possible to decrease the short-circuit occurrence rate after the charging and discharging cycle both upon the 4.2-volt charging and upon the 4.3-volt charging by providing the thin part in the positive electrode active material layer and providing the deactivated part having a predetermined thickness in the thin part.

Although the present disclosure has been described hereinabove with reference to one or more embodiments including modification examples, a configuration of the present disclosure is not limited thereto, and is therefore modifiable in a variety of ways. For example, in the foregoing embodiment, the thin part 61 serving as the first thin part is provided at the position in contact with the winding center side edge 21E1 of the positive electrode 21. However, the present disclosure is not limited to the above-described configuration. The first thin part, e.g., the thin part 61, may be provided at a location, in the positive electrode 21, away from the winding center side edge 21E1. Similarly, the thin part 62 serving as the second thin part does not necessarily have to be provided at the position in contact with the winding outer periphery side edge 21E2 of the positive electrode 21. The second thin part, e.g., the thin part 62, may be provided at a location, in the positive electrode 21, away from the winding outer periphery side edge 21E2.

Further, in the secondary battery according to the foregoing embodiment, the position of the first border in the first positive electrode active material layer and the position of the second border in the second positive electrode active material layer were different from each other in the longitudinal direction of the electrode wound body. However, the present disclosure is not limited to the above-described configuration. In the secondary battery of the present disclosure, the position of the first border and the position of the second border may substantially coincide with each other.

Further, in the secondary battery according to the foregoing embodiment, the positive electrode active material layer is provided on each of the two opposite surfaces of the positive electrode current collector. However, in the present disclosure, the positive electrode active material layer may be provided on only one of the two opposite surfaces of the positive electrode current collector. Similarly, in the present disclosure, the negative electrode active material layer may be provided on only one of the two opposite surfaces of the negative electrode current collector.

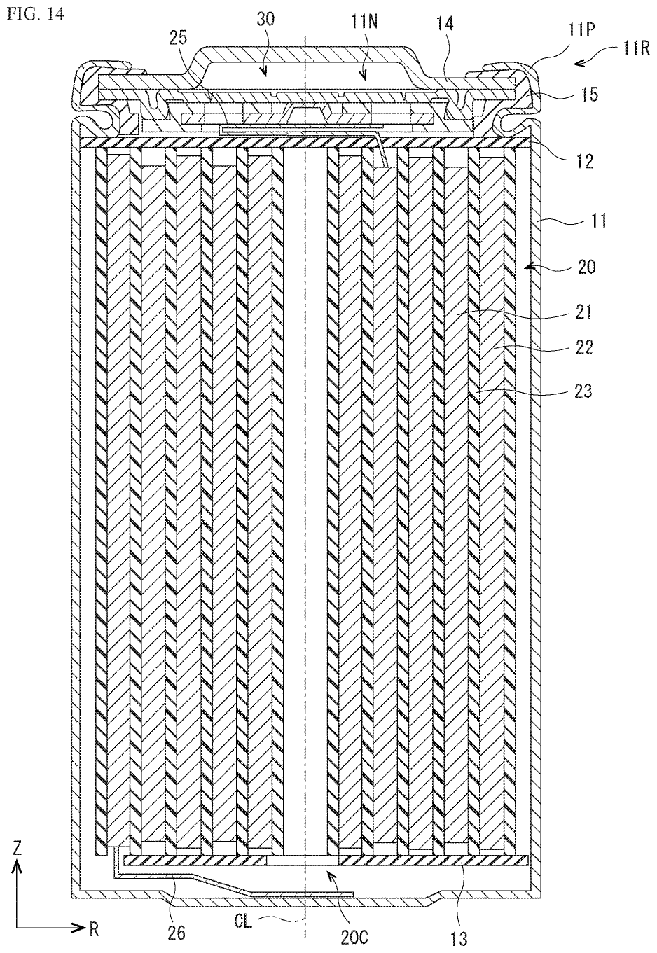

Further, the secondary battery of the present disclosure is not limited to the secondary battery illustrated in FIG. 1 and described in the foregoing embodiment. The secondary battery of the present disclosure may be, for example, a secondary battery illustrated in FIG. 14. In the secondary battery illustrated in FIG. 14, for example, the pair of insulating plates 12 and 13 and the electrode wound body 20 are contained inside the outer package can 11 having the cylindrical shape. The electrode wound body 20 is sandwiched between the insulating plate 12 and the insulating plate 13 in the Z direction. The safety valve mechanism 30 is attached to the outer package can 11. The outer package can 11 is sealed by the battery cover 14, for example. Note that the secondary battery may further include components including, without limitation, a thermosensitive resistive device, e.g., a PTC device, and a reinforcing member inside the outer package can 11. The safety valve mechanism 30 is provided on the inner side of the battery cover 14 in the Z direction. The safety valve mechanism 30 cancels the sealed state of the outer package can 11 to thereby release the internal pressure of the outer package can 11 on an as-needed basis upon an increase in the internal pressure. Examples of a cause of the increase in the internal pressure of the outer package can 11 may include a gas generated due to the decomposition reaction of the electrolytic solution upon charging and discharging.

Further, in the embodiment and Examples above, the description has been given of the case where the electrode reactant is lithium; however, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present disclosure are not limited to those described herein. Accordingly, the present disclosure may achieve any other effect.

The present disclosure may encompass any of the following description according to an embodiment.

According to the secondary battery of an embodiment of the present disclosure, the positive electrode active material layer includes the thin part. This makes it possible to reduce concentration of stress inside the outer package can occurring due to swelling of the negative electrode. Further, the presence of the deactivated part in the thin part of the positive electrode active material layer makes it possible to suppress extraction of an electrode reactant from the thin part of the positive electrode active material layer. As a result, it is possible to effectively reduce the concentration of stress inside the outer package can occurring due to the swelling of the negative electrode. Accordingly, it is possible to prevent a short circuit between the positive electrode and the negative electrode, and to thus achieve superior reliability.

Note that effects of the present disclosure are not necessarily limited to those described herein and may include any of a series of effects including described below in relation to the present disclosure according to an embodiment.

<1>

A secondary battery including:
an electrode wound body including a stacked body and having a through hole, the stacked body including a positive electrode, a negative electrode, and a separator and being wound along a longitudinal direction of the stacked body, the through hole extending through the electrode wound body in a width direction orthogonal to the longitudinal direction; and
an outer package can containing the electrode wound body, in which
the positive electrode includes
   a positive electrode current collector extending in both the longitudinal direction and the width direction, and
   a positive electrode active material layer provided on the positive electrode current collector and including a thin part and a thick part, the thick part having a thickness greater than a thickness of the thin part,
   one or more positive electrode active material particles are present on a surface, of the thin part, on an opposite side to the positive electrode current collector, each of the one or more positive electrode active material particles including a deactivated part, and
the deactivated part has a thickness smaller than 6.1 micrometers.
   <2>

The secondary battery according to <1> described above, in which the deactivated part has an oxygen mass concentration that is lower than an oxygen mass concentration of an effective part of the positive electrode active material particle, the effective part being a part, of the positive electrode active material particle, excluding the deactivated part.

<3>

The secondary battery according to <1> or <2> described above, in which the deactivated parts are present discretely on the surface of the thin part.

<4>

The secondary battery according to any one of <1> to <3> described above, in which the thin part and the thick part are adjacent to each other in the width direction.

<5>

The secondary battery according to any one of <1> to <4> described above, in which the thin part includes a winding center side edge of the positive electrode in the longitudinal direction.

<6>

The secondary battery according to any one of <1> to <5> described above, in which
the positive electrode further includes an insulating layer,
the positive electrode current collector includes a positive electrode covered region and a positive electrode exposed region, the positive electrode covered region being covered with the positive electrode active material layer, the positive electrode exposed region extending from the positive electrode active material layer in the width direction and being a region in which the positive electrode current collector is exposed without being covered with the positive electrode active material layer, and
the insulating layer extends in the longitudinal direction, along a first edge of the positive electrode active material layer, the first edge being positioned at a border between the positive electrode covered region and the positive electrode exposed region.
   <7>

The secondary battery according to any one of <1> to <3> described above, in which the thin part and the thick part are adjacent to each other in the longitudinal direction.

<8>

The secondary battery according to any one of <1> to <7> described above, in which
the positive electrode current collector includes an inward positive electrode current collector surface and an outward positive electrode current collector surface, the inward positive electrode current collector surface facing toward a winding center side of the electrode wound body, the outward positive electrode current collector surface facing toward an outer side opposite to the winding center side of the electrode wound body, and
each of the thick part and the thin part is provided on each of the inward positive electrode current collector surface and the outward positive electrode current collector surface.
   <9>

The secondary battery according to <7> described above, in which
the positive electrode current collector includes an inward positive electrode current collector surface and an outward positive electrode current collector surface, the inward positive electrode current collector surface facing toward a winding center side of the electrode wound body, the outward positive electrode current collector surface facing toward an outer side opposite to the winding center side of the electrode wound body,
the positive electrode active material layer includes a first positive electrode active material layer and a second positive electrode active material layer, the first positive electrode active material layer being provided on the inward positive electrode current collector surface, the second positive electrode active material layer being provided on the outward positive electrode current collector surface,
each of the first positive electrode active material layer and the second positive electrode active material layer includes the thin part and the thick part, and
a first length and a second length are different from each other, the first length being a length from a winding center side edge of the positive electrode in the longitudinal direction to a position of a first border between the thin part of the first positive electrode active material layer and the thick part of the first positive electrode active material layer, the second length being a length from the winding center side edge of the positive electrode in the longitudinal direction to a position of a second border between the thin part of the second positive electrode active material layer and the thick part of the second positive electrode active material layer.
   <10>

The secondary battery according to <7> described above, in which the positive electrode active material layer further includes a grooved part between the thick part and the thin part.

<11>

A battery pack including:
the secondary battery according to any one of <1> to <10> described above;
a controller configured to control the secondary battery; and
an outer package body that contains the secondary battery.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a stacked body and having a through hole, the stacked body including a positive electrode, a negative electrode, and a separator and being wound along a longitudinal direction of the stacked body, the through hole extending through the electrode wound body in a width direction orthogonal to the longitudinal direction; and
an outer package can including the electrode wound body, wherein
the positive electrode includes
a positive electrode current collector extending in both the longitudinal direction and the width direction, and
a positive electrode active material layer provided on the positive electrode current collector and including a thin part and a thick part, the thick part having a thickness greater than a thickness of the thin part,
one or more positive electrode active material particles are present on a surface, of the thin part, on an opposite side to the positive electrode current collector, each of the one or more positive electrode active material particles including a deactivated part, and the deactivated part has a thickness smaller than 6.1 micrometers.

2. The secondary battery according to claim 1, wherein the deactivated part has an oxygen mass concentration that is lower than an oxygen mass concentration of an effective part of the positive electrode active material particle, the effective part being a part, of the positive electrode active material particle excluding the deactivated part.

3. The secondary battery according to claim 1, wherein
the deactivated parts are present discretely on the surface of the thin part.

4. The secondary battery according to claim 1, wherein the thin part and the thick part are adjacent to each other in the width direction.

5. The secondary battery according to claim 1, wherein the thin part includes a winding center side edge of the positive electrode in the longitudinal direction.

6. The secondary battery according to claim 1, wherein
the positive electrode further includes an insulating layer,
the positive electrode current collector includes a positive electrode covered region and a positive electrode exposed region, the positive electrode covered region being covered with the positive electrode active material layer, the positive electrode exposed region extending from the positive electrode active material layer in the width direction and being a region in which the positive electrode current collector is exposed without being covered with the positive electrode active material layer, and
the insulating layer extends in the longitudinal direction, along a first edge of the positive electrode active material layer, the first edge being positioned at a border between the positive electrode covered region and the positive electrode exposed region.

7. The secondary battery according to claim 1, wherein the thin part and the thick part are adjacent to each other in the longitudinal direction.

8. The secondary battery according to claim 1, wherein
the positive electrode current collector includes an inward positive electrode current collector surface and an outward positive electrode current collector surface, the inward positive electrode current collector surface facing toward a winding center side of the electrode wound body, the outward positive electrode current collector surface facing toward an outer side opposite to the winding center side of the electrode wound body, and
each of the thick part and the thin part is provided on each of the inward positive electrode current collector surface and the outward positive electrode current collector surface.

9. The secondary battery according to claim 7, wherein
the positive electrode current collector includes an inward positive electrode current collector surface and an outward positive electrode current collector surface, the inward positive electrode current collector surface facing toward a winding center side of the electrode wound body, the outward positive electrode current collector surface facing toward an outer side opposite to the winding center side of the electrode wound body,
the positive electrode active material layer includes a first positive electrode active material layer and a second positive electrode active material layer, the first positive electrode active material layer being provided on the inward positive electrode current collector surface, the second positive electrode active material layer being provided on the outward positive electrode current collector surface,
each of the first positive electrode active material layer and the second positive electrode active material layer includes the thin part and the thick part, and
a first length and a second length are different from each other, the first length being a length from a winding center side edge of the positive electrode in the longitudinal direction to a position of a first border between the thin part of the first positive electrode active material layer and the thick part of the first positive electrode active material layer, the second length being a length from the winding center side edge of the positive electrode in the longitudinal direction to a position of a second border between the thin part of the second positive electrode active material layer and the thick part of the second positive electrode active material layer.

10. The secondary battery according to claim 7, wherein the positive electrode active material layer further includes a grooved part between the thick part and the thin part.

11. A battery pack comprising:
the secondary battery according to claim 1;
a controller configured to control the secondary battery; and
an outer package body that contains the secondary battery.
